(19) United States
(12) Patent Application Publication
(10) Pub. No.: US 2024/0427097 A1
(43) Pub. Date: Dec. 26, 2024

(54) OPTICAL CONNECTOR UNIT FOR A PHOTONIC ASSEMBLY AND METHODS FOR FORMING THE SAME

(71) Applicant: Taiwan Semiconductor Manufacturing Company Limited, Hsinchu (TW)

(72) Inventors: Chen-Hua Yu, Hsinchu City (TW); Chih-Wei Tseng, Hsinchu City (TW); Hsing-Kuo Hsia, Jhubei City (TW); Jiun Yi Wu, Zhongli City (TW)

(21) Appl. No.: 18/512,078

(22) Filed: Nov. 17, 2023

Related U.S. Application Data
(60) Provisional application No. 63/509,089, filed on Jun. 20, 2023.
(60) Provisional application No. 63/518,150, filed on Aug. 8, 2023.

(51) Int. Cl. G02B 6/43; G02B 6/42

(52) U.S. Cl. CPC G02B 6/43; G02B 6/4214; G02B 6/4239; G02B 6/4249; G02B 6/4283

(57) ABSTRACT

A photonic assembly includes: a composite die including a photonic integrated circuits (PIC) die and an electronic integrated circuits (EIC) die, the PIC die including waveguides and photonic devices therein, and the EIC die including semiconductor devices therein; and an optical connector unit including a first connector-side mirror reflector and a first transition edge coupler, wherein the first connector-side mirror reflector is configured to change a beam direction between a vertically-extending beam path through the composite die and a horizontally-extending beam path through the first transition edge coupler.

### RELATED APPLICATIONS

This application claims priority from U.S. Provisional Application Ser. No. 63/509,089 entitled “Integration of Optical Connector Die for Channeling Between Optical Fiver(s) and CPO Architecture,” filed on Jun. 20, 2023 and U.S. Provisional Application Ser. No. 63/518,150 entitled “Package Structure,” filed on Aug. 8, 2023, the entire contents of both of which are incorporated herein by reference for all purposes.

### BACKGROUND

Photonic integrated circuits (PICs) and electronic integrated circuits (EICs) are extensively used in modern electronics. PICs include photonic components formed in a photonic die, and electronic integrated circuits include semiconductor devices formed in a semiconductor die. PICs rely on light energy, and are supported by laser sources that enhance integration, speed, and heat reduction. The fabrication of PICs may use monolithic photonic integration or hybrid photonic integration. The utility of PICs spans across applications such as automotive sensors, healthcare systems, and data communication. PICs offer advantages such as energy efficiency, high speed, and integration compatibility with electronic integrated circuits.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a vertical cross-sectional view of a first embodiment structure of the present disclosure. FIG. 1B is a horizontal cross-sectional view along the horizontal plane B-B′ of the first embodiment structure of FIG. 1A. FIG. 1C is a horizontal cross-sectional view of the first embodiment structure of FIG. 1A. FIG. 1D is a horizontal cross-sectional view of an alternative configuration of the first embodiment structure of FIGS. 1A-1C along a horizontal plane that corresponds to the horizontal plane B-B′ in FIG. 1A. FIG. 1E is a horizontal cross-sectional view of the alternative configuration of the first embodiment structure of FIGS. 1A-1C along a horizontal plane that corresponds to the horizontal plane C-C′ in FIG. 1A.

FIG. 2A is a vertical cross-sectional view of a first embodiment of a mirror reflector and a transition edge coupler in an optical connector die according to an aspect of the present disclosure. FIG. 2B is a vertical cross-sectional view of a second embodiment of a mirror reflector and a transition edge coupler in an optical connector die according to an aspect of the present disclosure. FIG. 2C is a perspective view of a transition edge coupler according to an aspect of the present disclosure.

FIG. 3A illustrates a top-down view of a pair of waveguides that are coupled to each other through evanescent coupling. FIG. 3B is a side view of the pair of waveguides illustrated in FIG. 3A.

FIG. 4A is a vertical cross-sectional view of a second embodiment structure of the present disclosure. FIG. 4B is a horizontal cross-sectional view along the horizontal plane B-B′ of the second embodiment structure of FIG. 4A. FIG. 4C is a horizontal cross-sectional view of the second embodiment structure of FIG. 4A. FIG. 4D is a horizontal cross-sectional view of an alternative configuration of the second embodiment structure of FIGS. 4A-4C along a horizontal plane that corresponds to the horizontal plane B-B′ in FIG. 4A. FIG. 4E is a horizontal cross-sectional view of the alternative configuration of the second embodiment structure of FIGS. 4A-4C along a horizontal plane that corresponds to the horizontal plane C-C′ in FIG. 4A.

FIGS. 5A-5D are sequential vertical cross-sectional views of an exemplary structure during formation of an optical connector die.

FIG. 6A is a vertical cross-sectional view of a third embodiment structure according to an aspect of the present disclosure. FIG. 6B is a vertical cross-sectional view of an alternative configuration of the third embodiment structure according to an aspect of the present disclosure.

FIG. 7A is a vertical cross-sectional view of a fourth embodiment structure according to an aspect of the present disclosure. FIG. 7B is a vertical cross-sectional view of an alternative configuration of the fourth embodiment structure according to an aspect of the present disclosure.

FIG. 8A is a vertical cross-sectional view of a fifth embodiment structure according to an aspect of the present disclosure. FIG. 8B is a vertical cross-sectional view of an alternative configuration of the fifth embodiment structure according to an aspect of the present disclosure.

FIGS. 9A-9X are vertical cross-sectional views of various configurations of a sixth embodiment structure according to an aspect of the present disclosure.

FIG. 10 is a vertical cross-sectional view of a fiber array units assembly according to an aspect of the present disclosure.

FIGS. 11A-11H are vertical cross-sectional views of various configurations of a seventh embodiment structure according to an aspect of the present disclosure.

FIGS. 12A-12F are vertical cross-sectional views of various configurations of an eighth embodiment structure according to an aspect of the present disclosure.

FIGS. 13A-13F are sequential vertical cross-sectional views of an exemplary structure during formation of an optical connector die.

FIG. 14A is a vertical cross-sectional view of a ninth embodiment structure of the present disclosure. FIG. 14B is a horizontal cross-sectional view along the horizontal plane B-B′ of the ninth embodiment structure of FIG. 14A. FIG. 14C is a horizontal cross-sectional view of the ninth embodiment structure of FIG. 14A. FIG. 14D is a horizontal cross-sectional view of the ninth embodiment structure of FIG. 14A.

FIG. 15A is a vertical cross-sectional view of a tenth embodiment structure of the present disclosure. FIG. 15B is a horizontal cross-sectional view along the horizontal plane B-B′ of the tenth embodiment structure of FIG. 15A. FIG. 15C is a horizontal cross-sectional view of the tenth embodiment structure of FIG. 15A. FIG. 15D is a horizontal cross-sectional view of the tenth embodiment structure of FIG. 15A.

FIGS. 16A-16H are vertical cross-sectional views of various configurations of an eleventh embodiment structure according to an aspect of the present disclosure.

FIG. 17A is a vertical cross-sectional view of a twelfth embodiment structure according to an aspect of the present disclosure. FIG. 17B is a top-down view of the twelfth embodiment structure of FIG. 17A.

FIG. 18A is a vertical cross-sectional view of a twelfth embodiment structure according to an aspect of the present disclosure. FIG. 18B is a top-down view of the twelfth embodiment structure of FIG. 18A.

FIG. 19 is a flowchart illustrating general processing steps for forming a photonic assembly of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Elements with the same reference numerals are presumed to be the same element or similar elements, and are presumed to have the same material composition and provide the same function, unless expressly described otherwise.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Elements with the same reference numerals refer to the same element, and are presumed to have the same material composition and the same thickness range unless expressly indicated otherwise. As used herein, an element or a system “configured for” a function or an operation or “configured to” provide or perform a function or an operation refers to an element or a system that is provided with hardware, and with software as applicable, to provide such a function or such an operation as described in the present disclosure, and as known in the art in the event any details of such hardware or such software are not expressly described herein.

A compact universal photonic engine (COUPE) includes a combination of PICs and EICs that provides optical-electrical transmission. A COUPE allows for the processing of optical signals using an electronic signal transmission system. A COUPE integrates various optical components, electro-optics transition devices, and optical fibers. In optical-electrical devices, laser light plays a pivotal role. Optical fibers may be used to feed laser light to a COUPE. The laser light may pass through a supporting silicon substrate. The laser light may be re-focused and re-concentrated through optical lenses to reduce spatial light divergence.

According to an aspect of the present disclosure, the COUPE may include optical elements for effectively channeling of the laser light (also referred simply as light) to optical devices in a die. According to an aspect of the present disclosure, the COUPE may include an exterior adapter with high quantities of repetition, manufactured in die/chip form and compatible with the CMOS fabrication process. In addition, an optical deflector may be provided in a COUPE die to couple vertically-propagating laser light to horizontally-extending waveguides within the COUPE die. Specifically, the COUPE die of the various embodiments may include a COUPE-based optical-electrical transmission systems that includes an optical connector module that is attached to, or integrated into, a COUPE die, an optical deflector formed within the COUPE die, and a vertical light path between the optical connector module and the optical connector module. The COUPE die provides compactness in CPO by deflecting the optical output/input into horizontal transmission instead of vertical output, which facilitates other horizontal coupling methodologies such as fiber array units (FAU).

Various embodiments disclosed herein may provide a versatile optical connector located on, or within, a COUPE die. The optical connector may function as a self-aligned optical conduit between external optical fibers or light coupler apparatus and the waveguides within co-packaged optics (CPO) in the COUPE die. Further, the optical path may be extended subsequent to emission from focusing lenses located on the support semiconductor substrate. The optical deflector of the various embodiments may provide flexible channeling of the light between photonic integrated circuits (PICs) and the fibers or light coupler apparatus. Various embodiments of the present disclosure may provide diverse coupling modes for optical fibers or light coupler apparatus, encompassing both vertical and horizontal coupling styles. Embodiments of the present disclosure may be used in such fields as photonic integrated circuits, silicon photonics, three-dimensional integrated chips with photonics applications, and/or the COUPE technology in general.

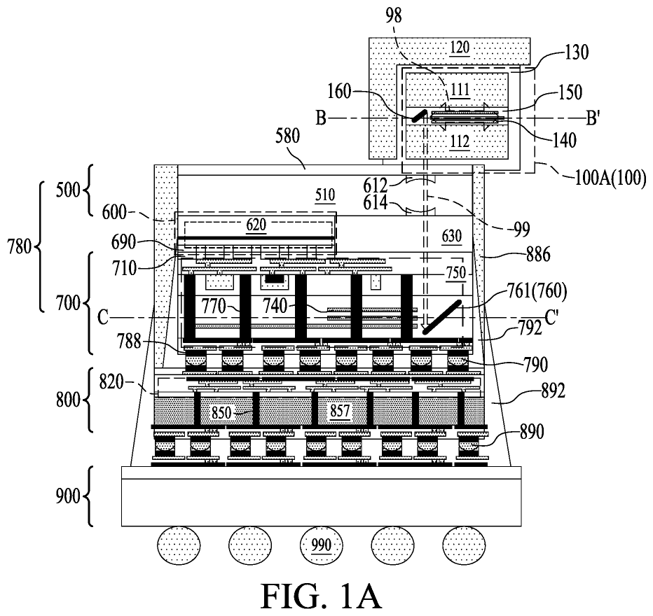

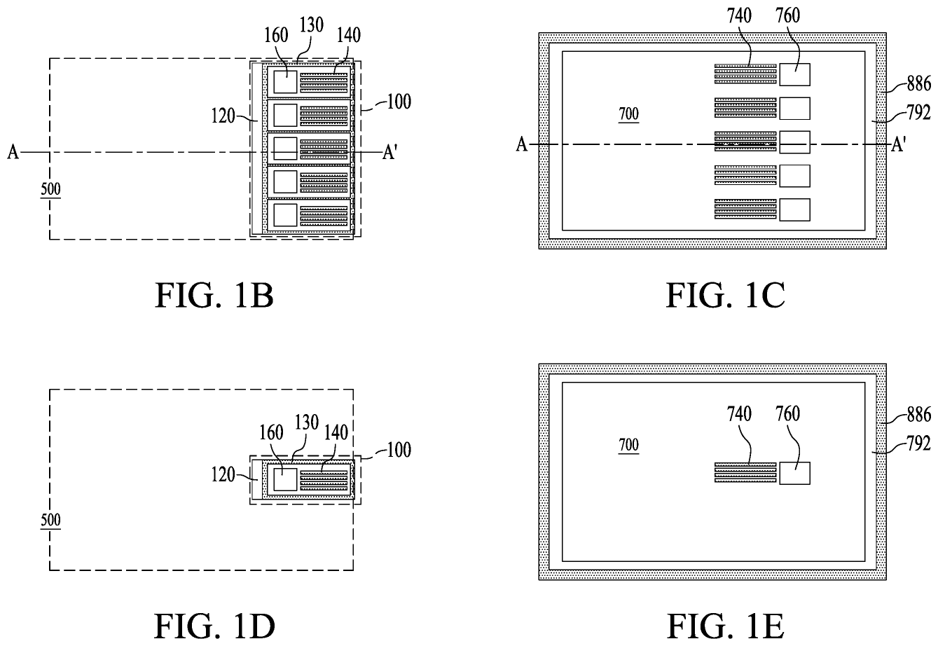

FIG. 1A is a vertical cross-sectional view of a first embodiment structure of the present disclosure. FIG. 1B is a horizontal cross-sectional view along the horizontal plane B-B′ of the first embodiment structure of FIG. 1A. FIG. 1C is a horizontal cross-sectional view along the horizontal plane C-C′ of the first embodiment structure of FIG. 1A. FIG. 1D is a horizontal cross-sectional view of an alternative configuration of the first embodiment structure of FIGS. 1A-1C along a horizontal plane that corresponds to the horizontal plane B-B′ in FIG. 1A. FIG. 1E is a horizontal cross-sectional view of the alternative configuration of the first embodiment structure of FIGS. 1A-1C along a horizontal plane that corresponds to the horizontal plane C-C′ in FIG. 1A. FIGS. 1B and 1C illustrates a configuration in which a plurality of optical connector units 100 are attached proximal to or on a top surface of a composite die 780. FIGS. 1D and 1E illustrate a configuration in which a single optical connector unit 100 is attached proximal to or on a top surface of a composite die 780. The vertical plane A-A′ in FIGS. 1B-1E is the cut plane of the vertical cross-sectional view of FIG. 1A. While the first embodiment structure is hereafter described using an embodiment including an optical connector unit 100, it should be understood that additional optical connector units 100 may be present in addition to the optical connector unit 100 that is described herein. Likewise, a plurality of optical deflectors 760 may be provided in a photonic integrated circuits (PIC) die 700. In one embodiment, the total number of the optical deflectors 760 may be the same as the total number of the optical connector units 100. According to an aspect of the present disclosure, the optical connector unit 100 can be an exterior adapter with high quantities of repetition, manufactured in die/chip form and compatible with the CMOS fabrication process.

Referring collectively to FIGS. 1A-1E, the first embodiment structure comprises an optical assembly including a composite die 780. The composite die 780 comprises a compact universal photonic engine (COUPE) (600, 700), which includes a combination of photonic integrated circuits provided in a photonic integrated circuits (PIC) die 700 and electronic integrated circuits provided in an electronic integrated circuits (EIC) die 600. The optical assembly generally include electro-optics transition devices and optical fibers (not shown) that provide light. The area of a substrate 500 is illustrated in FIGS. 1B and 1D by a dotted rectangle.

The composite die 780 may be formed by providing a PIC die 700 and an EIC die 600. The PIC die 700 comprises various types of photonic devices 750 known in the art, an optical deflector 760 configured to change the direction of an optical beam, waveguides 740 providing optical paths between optical nodes of the various photonic devices 750 and between the optical deflector 760 and a subset of the waveguides 740, and metal interconnect structures 770 configured to provide electrical signals to the various electrical nodes of the photonic devices 750. In one embodiment, the optical deflector 760 may comprise an in-die mirror 761 having a tilt angle of 45 degrees relative to a vertical direction.

A top side of the PIC die 700 may comprise metallic bonding pads configured for metal-to-metal bonding (such as copper-to-copper bonding), which are herein referred to as PIC metallic bonding pads 710. A bottom side of the PIC die 700 may comprise on-die bump structures 788, i.e., bump structures that are formed on a die. The on-die bump structures 788 may comprise microbump structures (i.e. C2 bump structures) or C4 bump structures. The metal interconnect structures 770 within the PIC die 700 provide electrical connection between the PIC metallic bonding pads 710 and the on-die bump structures 788. In some embodiments, the PIC die 700 may be made from a semiconductor-on-insulator (SOI) wafer. Generally, an array of PIC dies 700 may be provided as a two-dimensional periodic array of PIC dies 700 within a wafer.

The EIC die 600 comprises semiconductor devices 620 that form the electronic integrated circuits. The semiconductor devices 620 may comprise field effect transistors, diodes, resistors, capacitors, inductors, or various other types of semiconductor devices that may be manufactured on a semiconductor substrate. Further, metal interconnect structures (not expressly shown) embedded within dielectric material layers including interlayer dielectric (ILD) materials) may be provided in the EIC die 600. In addition, the EIC die may comprise metallic bonding pads configured for metal-to-metal bonding, which are herein referred to as EIC metallic bonding pads 690. The EIC metallic bonding pads 690 may be arranged in a mirror image pattern of the pattern of the PIC metallic bonding pads 710. According to an aspect of the present disclosure, the EIC die 600 may have a smaller lateral extent than the PIC die 700. Thus, the EIC die 600 may fit within the area of the PIC die 700 in a plan view upon aligning the EIC die 600 with the PIC die 700 for metal-to-metal bonding between the PIC metallic bonding pads 710 and the EIC metallic bonding pads 690.

The EIC die 600 may be attached to the PIC die 700, for example, by bonding the EIC metallic bonding pads 690 to the PIC metallic bonding pads 710 through metal-to-metal bonding, such as copper-to-copper bonding). In embodiments in which a wafer including a two-dimensional array of PIC dies 700 is provided, a plurality of EIC dies 600 may be bonded to a respective PIC die 700 within the two-dimensional array of PIC dies 700. A dielectric fill material such as a molding compound material, a polymer material, or a silicon oxide material (such as flowable oxide) may be deposited in the gaps between neighboring pairs of EIC dies 600 over the wafer including the two-dimensional array of PIC dies 700. A planarization process such as a chemical mechanical polishing process may be performed to remove portions of the dielectric fill material from above the horizontal plane including the top surfaces of the EIC dies 600. The remaining portion of the dielectric fill material comprises a dielectric matrix 630.

A semiconductor layer including optical lenses (612, 614) may be attached to the top surface of a reconstituted wafer including a two-dimensional array of PIC dies 700, a two-dimensional array of EIC dies 600, and the dielectric matrices 630. The semiconductor layer is used as a support structure, and is herein referred to as a support semiconductor substrate 510. The optical lenses (612, 614) may be formed, for example, by forming recess cavities including non-planar surfaces (such as convex surfaces) in the path of an optical beam, such as a vertically-extending beam path 99, and by filing the recess cavities by an optically transparent material such as silicon oxide. The optical lenses (612, 614) may comprise distal substrate lenses 612 that are formed on a distal side of the support semiconductor substrate 510 (i.e., a side that is distal from the PIC die 700), and proximal substrate lenses 614 that are formed on a proximal side of the support semiconductor substrate 510 (i.e., a side that is proximal to the PIC die 700). The optical lenses (612, 614) may be used to focus a light beam that travels through the support semiconductor substrate 510.

Through-substrate via structures (not shown) may be optically formed through the support semiconductor substrate 510 to provide vertically-extending electrically conductive paths, which may be used to provide additional electrical connections to the electrical nodes of the semiconductor devices 620. The support semiconductor substrate 510 may be bonded to the combination of the array of EIC dies 600 and the dielectric matrices 630 by semiconductor-to-insulator bonding (such as silicon-to-oxide bonding or silicon-to-polymer bonding), or a thin layer of semiconductor oxide layer (not shown) may be formed on a bottom surface of the support semiconductor substrate 510, for example, by oxidation, and oxide-to-insulator bonding may be used. A suitable thermal anneal at an elevated temperature may be used to bond the support semiconductor substrate 510 to the combination of the array of EIC dies 600 and the dielectric matrices 630. The thickness of the support semiconductor substrate 510 may be in a range from 5 microns to 30 microns, although lesser and greater thicknesses may also be used.

An optically transparent dielectric layer 580 may be deposited on a top surface of the support semiconductor substrate 510. The optically transparent dielectric layer 580 may include a polymer or silicon oxide. The thickness of the optically transparent dielectric layer 580 may be in a range from 1 micron to 10 microns, although lesser and greater thicknesses may also be used. The combination of the support semiconductor substrate 510 and the optically transparent dielectric layer 580 constitutes a substrate 500. As used herein, an optically transparent element refers to an element having an optical extinction coefficient (i.e., an imaginary part of a refractive index) less than 0.0001 within the wavelength range of the light used in optical communication, such as a wavelength range from 500 nm to 2,000 nm.

The reconstituted wafer including the two-dimensional array of PIC dies 700, the two-dimensional array of EIC dies 600, the dielectric matrices 630, and the substrate 500 may be diced along dicing channels to form a plurality of composite dies 780. Thus, each composite die 780 comprises a respective PIC die 700, a respective EIC die 600, a respective dielectric matrix 630, a respective support semiconductor substrate 510, and a respective optically transparent dielectric layer 580. Within each composite die 780, sidewalls of the PIC die 700 may be vertically coincident with sidewalls of the dielectric matrix 630, sidewalls of the support semiconductor substrate 510, and sidewalls of the optically transparent dielectric layer 580, and may be vertically coincident with a sidewall of the EIC die 600. As used herein, a first surface is vertically coincident with a second surface in instances in which the second surface overlies or underlies the first surface and in instances in which there exists a vertical plane including the first surface and the second surface.

The composite die 780 may be bonded to an interposer wafer including a two-dimensional array of interposers 800. Each interposer 800 may comprise, for example, through-interposer via structures 850 vertically extending through an interposer matrix 857, metal interconnect wing 820 providing electrically conductive paths, die-side bump structures having a mirror image pattern of the on-die bump structures 788 and facing the composite die 780, and substrate-side bump structures located on an opposite side of the die-side bump structures. In some embodiments, the substrate-side bump structures may comprise C4 bonding pads.

Composite dies 780 may be bonded to a respective one of the interposers 800 in the interposer wafer using arrays of first solder material portions 790. A first underfill material portion 792 may be applied around each array of first solder material portions 790 between a respective bonded pair of a composite die 780 and an interposer 800. A molding compound material may be applied to the gaps between neighboring pairs of composite dies 780. Excess portions of the molding compound material may be removed from above the horizontal plane including top surfaces of the composite dies 780 by a planarization process such as a chemical mechanical polishing process. The remaining portion of molding compound material constitutes a molding compound matrix. A reconstituted wafer including the interposer wafer, the array of composite dies 780, and the molding compound matrix may be diced along dicing channels to form a bonded assembly (780, 800, 886) including a composite die 780, and interposer 800, and a molding compound die frame 886. Sidewalls of the molding compound die frame 886 may be vertically coincident with sidewall of the packaging substrate 900.

The bonded assembly (780, 800, 886) may be bonded to a packaging substrate 900 through an array of second solder material portions 890. The second solder material portions 890 may comprise microbump solder balls or C4 solder balls. A second underfill material portion 892 may be formed around the second solder material portions 890 between the interposer 800 and the packaging substrate 900. The optical connector unit 100 may be attached to the composite die 780 prior to, or after, attaching solder joints 990 to the packaging substrate 900.

The bonded assembly (780, 800, 886) may comprise a photonic assembly (i.e., an assembly including photonic devices therein) including the composite die 780. The composite die 780 comprises at least one optical path that includes a vertically-extending beam path 99 that extends from an optical deflector 760 embedded within the PIC die 700 through the dielectric matrix 630, through the support semiconductor substrate 510 and at least one optical lens (612, 614) thereupon, and into the optically transparent dielectric layer 580. According to an aspect of the present disclosure, an optical connector unit 100 may be mounted to a location at an extension of the vertically-extending beam path 99. In some embodiments, the optical connector unit 100 may comprise a first connector-side mirror reflector 160 and a first transition edge coupler 140, and may be mounted on the composite die 780 such that the vertically-extending beam path intersects the first connector-side mirror reflector 160. The first connector-side mirror reflector 160 changes the beam propagation direction of a beam traveling along the vertically-extending beam path 99 to a horizontal direction. The path of an optical beam that traves along the horizontal direction is herein referred to a horizontally-extending beam path 98, which extends through the first transition edge coupler 140. In an alternative embodiment to be subsequently described, the optical connector unit 100 may be formed within the composite die 780, for example, in the optically transparent dielectric layer 580.

Generally, a composite die 780 including a photonic integrated circuits (PIC) die 700 and an electronic integrated circuits (EIC) die 600 may be formed. The PIC die 700 comprising waveguides 740 and photonic devices 750 therein, and the EIC die 600 comprising semiconductor devices 620 therein. An optical connector unit 100 comprising a first connector-side mirror reflector 160 and a first transition edge coupler 140 within, or on, the composite die 780, wherein the first connector-side mirror reflector 160 is configured to change a beam direction between a vertically-extending beam path 99 through the composite die 780 and a horizontally-extending beam path 98 through the first transition edge coupler 140.

In an embodiment illustrated in FIGS. 1A-1E, the optical connector unit 100 comprises an optical connector die 100A that is attached to a top surface of the composite die 780 using an optical glue portion 130. The optical glue portion 130 may comprise an optical glue material known in the art. In an illustrative example, the optical glue portion 130 may comprise an epoxy material composition containing components that provide curing when exposed to visible light or a reaction accelerant liquid. Typically, more than 50% in weight percentage of the optical glue material may comprise small particles. In embodiments in which the optical glue composition is cured through exposure to light, the optical glue composition may comprise an initiator or a sensitizer, and the particles in the optical glue composition may have two different sizes. Once the optical glue composition is set, optical characteristics of the optical glue portion 130 may be changed. For example, the optical glue composition may change the way light bends through it and how it responds to temperature changes. In an alternative embodiment, the optical glue composition may comprise epoxy material at a weight percentage in a range from 5% to 49.9%, a small amount of the liquid, and a light-reacting system. The liquid also includes a small amount of an initiator and a sensitizer. Small particles make up more than half of the weight of the optical glue composition.

In one embodiment, an encapsulation cover 120 may be attached to the optical connector die 100A. The encapsulation cover 120 provides enhanced structural strength to the region in which the optical connector die 100A is attached to the composite die 780. In one embodiment, the encapsulation cover 120 has a horizontally-extending portion overlying the optical connector die 100A and a vertically-extending portion that is attached to a sidewall of the optical connector die 100A through the optical glue portion 130.

Generally, the first connector-side mirror reflector 160 may be configured to change a beam direction between the vertically-extending beam path 99 through the composite die 780 and the horizontally-extending beam path 98 through the first transition edge coupler 140. In one embodiment, the first connector-side mirror reflector 160 may comprise a tilted mirror facing downward and sideways such that a reflection plane of the tilted mirror is tilted by 45 degrees relative to a vertical direction.

The optical glue portion 130 bonds a bottom surface of the optical connector die 100A to the top surface of the composite die 780, and also bonds the encapsulation cover 120 to the optical connector die 100A and to the composite die 780. In one embodiment, the composite die 780 comprises a support semiconductor substrate 510 interposed between the PIC die 700 and the optical connector unit 100, the vertically-extending beam path 99 vertically extends through the support semiconductor substrate 510. In one embodiment, the optically transparent dielectric layer 580 overlies a top surface of the support semiconductor substrate 510, and the optical connector unit 100 is located over the optically transparent dielectric layer 580.

In one embodiment, the optical connector unit 100 comprises a dielectric matrix layer 150 embedding the first connector-side mirror reflector 160 and the first transition edge coupler 140, a second spacer plate 112 interposed between the composite die 780 and the dielectric matrix layer 150, and a first spacer plate 111 located over the first connector-side mirror reflector 160 and more distal from the composite die 780 than the first connector-side mirror reflector 160.

In one embodiment, the PIC die 700 comprises an optical deflector 760, and the first connector-side mirror reflector 160 is configured to change a beam direction between a vertically-extending beam path 99 extending between the optical deflector 760 and the first connector-side mirror reflector 160 and through the support semiconductor substrate 510 and a first horizontally-extending beam path 98 through the first transition edge coupler 140. In one embodiment, the PIC die 700 comprises waveguides 740 that laterally extend along a horizontal direction, the optical deflector 760 comprises an in-die mirror 761 configured to change the beam direction between a second horizontally-extending beam path 98 through a subset of the waveguides 740 and the vertically-extending beam path 99.

According to an aspect of the present disclosure, the first connector-side mirror reflector 160 changes the optical path from the vertically-extending beam path 99 to the horizontally-extending beam path 98 for beams that exit the composite die 780, and changes the optical path from the horizontally-extending beam path 98 to the vertically-extending beam path 99 for beams that enter the first transition edge coupler 140. The first transition edge coupler 140 is optically coupled to an external optical module (not illustrated) or an external optical component (not illustrated). For example, the external optical module may comprise a fiber array units assembly that includes optical fibers. In one embodiment, light exiting the first transition edge coupler 140 enters the optical fibers, and vice versa. In this embodiment, the optical fibers may be aligned to the first transition edge coupler 140 to maximize optical transmission therebetween. The at least one optical lens (612, 614) embedded in the support semiconductor substrate 510 refocuses the light that travels along the vertically-extending beam path 99. Thus, the optical connector unit 100 (such as the optical connector die 100A) of the present disclosure changes a beam direction between a vertical direction and a horizontal direction. Embodiments of the present disclosure provide redirection of an optical output/input between a vertical direction and a horizontal direction, and optical coupling between the composite die 780 and an external optical module.

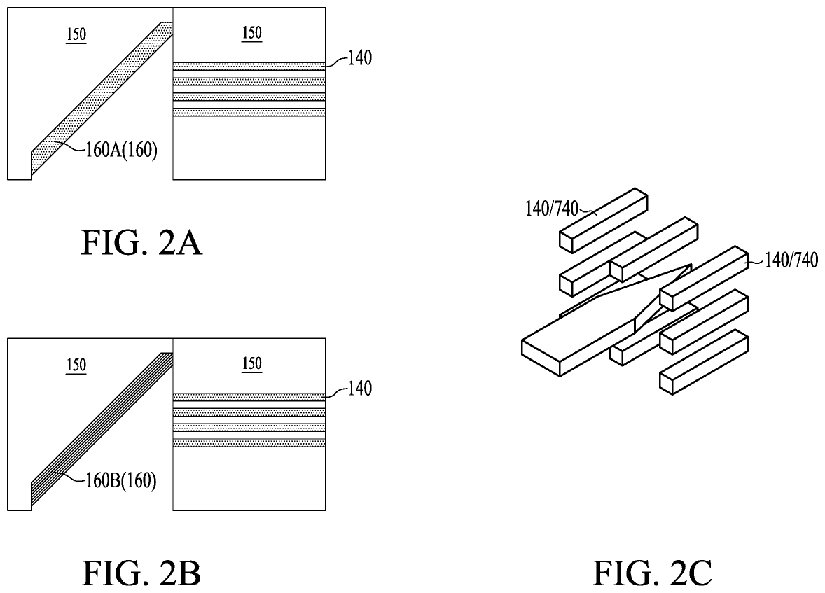

FIG. 2A is a vertical cross-sectional view of a first embodiment of a mirror reflector 160 and a transition edge coupler 140 in an optical connector die 100A according to an aspect of the present disclosure. FIG. 2B is a vertical cross-sectional view of a second embodiment of a mirror reflector 160 and a transition edge coupler 140 in an optical connector die 100A according to an aspect of the present disclosure. FIG. 2C is a perspective view of the first transition edge coupler 140 or waveguides 740 having a configuration of a transition edge coupler according to an aspect of the present disclosure.

Referring to FIG. 2A, a first configuration for the first connector-side mirror reflector 160 is illustrated. In one embodiment, the first connector-side mirror reflector 160 may comprise a metal-coated mirror 160A including a coating of a metal such as a layer stack of Cu/Al/Ta, an Al—Cu compound, an Al—Cu—Si compound, etc.

Referring to FIG. 2B, a second configuration for the first connector-side mirror reflector 160 is illustrated. In one embodiment, the first connector-side mirror reflector 160 may comprise a superlattice 160B of dielectric material layers in which a repetition unit including at least two dielectric material layers is repeated with a periodicity to maximize the reflectivity at the wavelength of the optical beam. The total number of repetitions of the repetition unit may be in a range from 2 to 20, although a greater number may also be used.

Referring to FIG. 2C, the first transition edge coupler 140 and/or a subset of the waveguides 740 that are proximal to the optical deflector 760 may have a configuration of a transition edge coupler. A Transition Edge Coupler (TEC) provide efficient optical signal transfer between optical components. The TEC functions as a resonator that optimally bridges the impedance mismatch between proximal end portions of two optical components. This resonance facilitates photon exchange between the two optical components. Additionally, the TEC's nonlinear signal coupling characteristics provide suppression of noise during transmission of an optical signal between two optical components. In an illustrative example, the first transition edge coupler 140 and/or a subset of the waveguides 740 that are proximal to the optical deflector 760 may comprise a plurality of waveguides laterally surrounding a central waveguide including a gradually increasing lateral dimension.

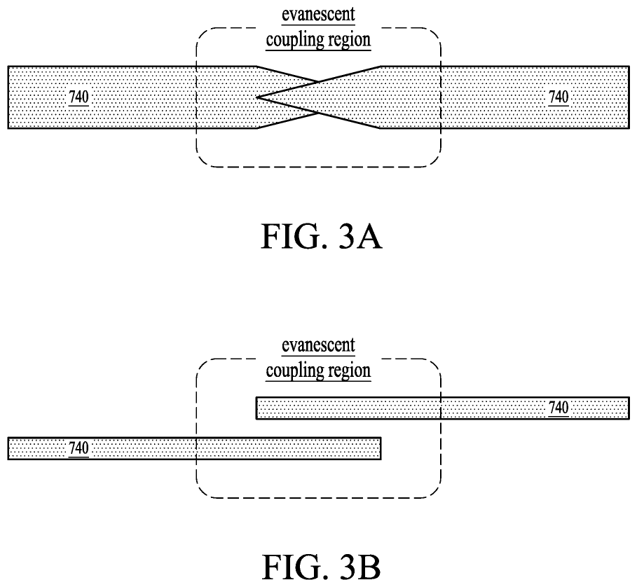

FIG. 3A illustrates a top-down view of a pair of waveguides 740 that are coupled to each other through evanescent coupling. FIG. 3B is a side view of the pair of waveguides 740 illustrated in FIG. 3A. Generally, optical coupling between the waveguides 740 in the PIC die 700 may be provided by evanescent coupling. In this embodiment, an end of a first waveguide 740 located at a first level (i.e., a vertical distance from an underlying reference horizontal plane such as a bottom surface of the PIC die 700) may have a lateral taper such that the first waveguide 740 terminates over, or under, a portion of a second waveguide 740 having a full width, and an end portion of the second waveguide 740 may have a lateral taper such that that the second waveguide 740 terminates under, or over, a portion of the first waveguide having a full width. The second waveguide 740 is located at a second level that is different from the first level.

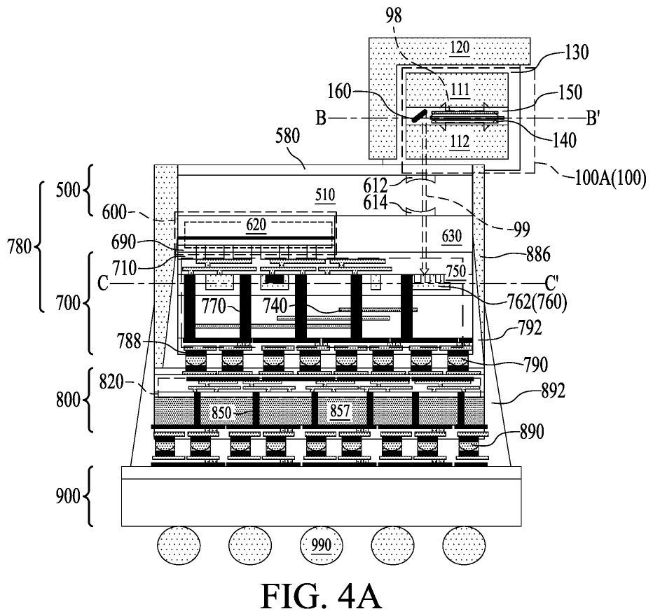

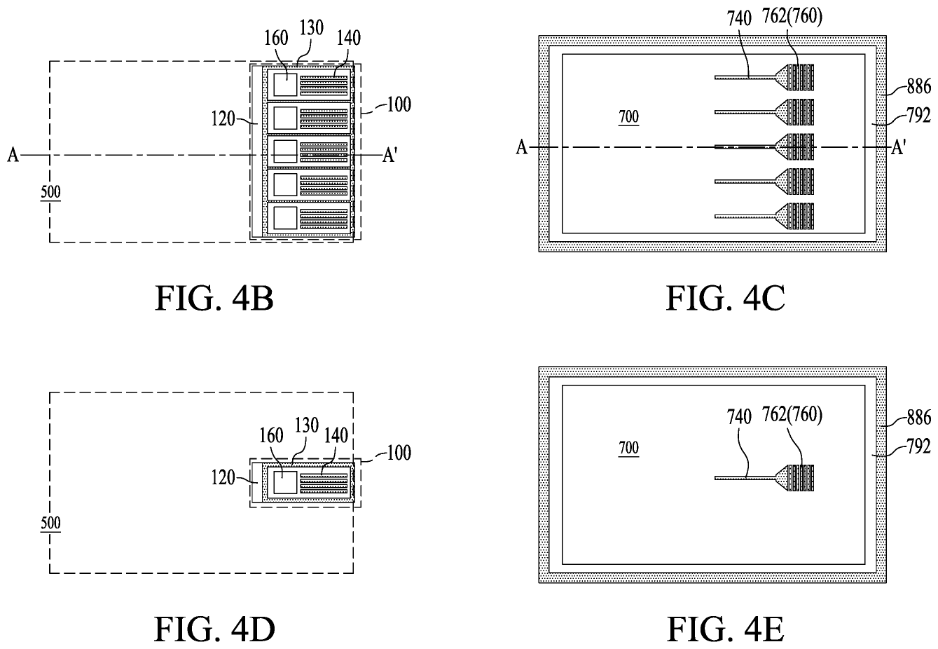

FIG. 4A is a vertical cross-sectional view of a second embodiment structure of the present disclosure. FIG. 4B is a horizontal cross-sectional view along the horizontal plane B-B′ of the second embodiment structure of FIG. 4A. FIG. 4C is a horizontal cross-sectional view along the horizontal plane C-C′ of the second embodiment structure of FIG. 4A. FIG. 4D is a horizontal cross-sectional view of an alternative configuration of the second embodiment structure of FIGS. 4A-4C along a horizontal plane that corresponds to the horizontal plane B-B′ in FIG. 4A. FIG. 4E is a horizontal cross-sectional view of the alternative configuration of the second embodiment structure of FIGS. 4A-4C along a horizontal plane that corresponds to the horizontal plane C-C′ in FIG. 4A. The vertical plane A-A′ in FIGS. 4B-4E is the cut plane of the vertical cross-sectional view of FIG. 4A. While the first embodiment structure is hereafter described using an embodiment including an optical connector unit 100, it should be understood that additional optical connector units 100 may be present in addition to the optical connector unit 100 that is described herein. Likewise, a plurality of optical deflectors 760 may be provided in a photonic integrated circuits (PIC) die 700. In one embodiment, the total number of the optical deflectors 760 may be the same as the total number of the optical connector units 100. The optical connector unit 100 may be attached to the composite die 780 prior to, or after, attaching solder joints 990 to the packaging substrate 900.

In the second embodiment structure, a grating coupler 762 may be used in lieu of an in-die mirror 761 as the optical deflector 760 in the PIC die 700 of FIGS. 1A-1E. One end of the grating coupler 762 may comprise a waveguide 740, which may be optically connected to at least one additional waveguide 740, for example, by evanescent coupling. The grating coupler 762 comprises an optical grating having a periodicity along a horizontal direction. Generally, the grating coupler 762 may be used to efficiently couple light between a waveguide 740 in the PIC die 700 and a vertically-propagating beam that propagates through an upper portion of the PIC die 700, the dielectric matrix 630, the support semiconductor substrate 510, and the optically transparent dielectric layer 580. The grating coupler 762 may comprise a periodic pattern of alternating transparent and opaque sections. The periodicity of the periodic pattern is selected to maximize optical coupling at the wavelength of the light to be used for photonic signal transmission. As light encounters the grating of the grating coupler 762 from a vertical direction, the light undergoes scattering. The dimensions of the grating may be selected such that the light constructively interferes only along the direction of a waveguide 740. The same principle applies for the light exiting the waveguide 740 and impinging the grating coupler 762, and causes constructive interference only along the vertical direction, which is the exit direction of the light.

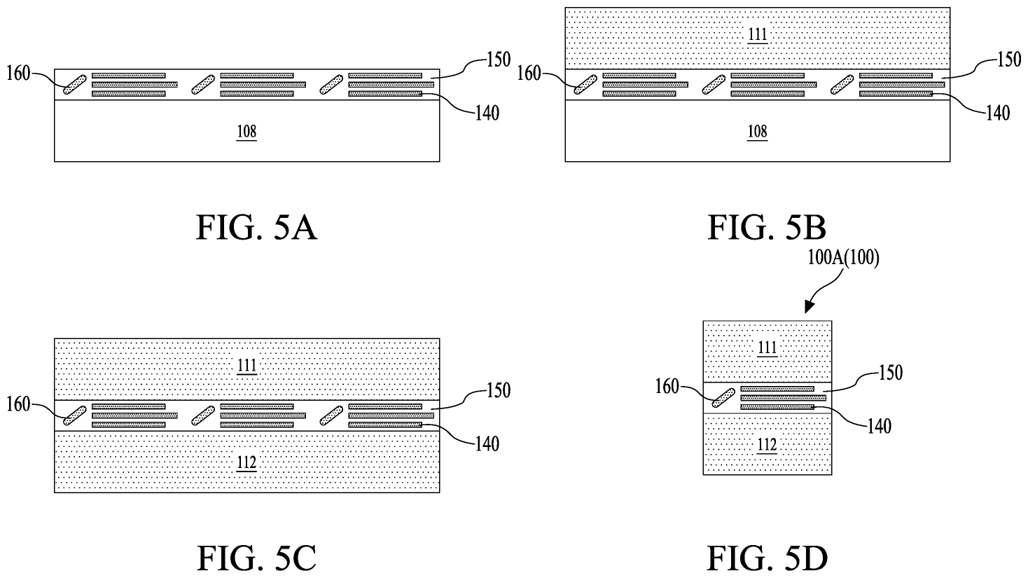

FIGS. 5A-5D are sequential vertical cross-sectional views of an exemplary structure during formation of an optical connector die 100A.

Referring to FIG. 5A, an array of unit devices embedded in a dielectric matrix layer 150 may be formed on a carrier wafer 108. Each unit device may comprise at least one connector-side mirror reflector 160 and at least one transition edge coupler 140. The dielectric matrix layer 150 comprises an optically transparent material such as silicon oxide or a transparent polymer material, and may have a thickness in a range from 10 microns to 300 microns, such as from 20 microns to 150 microns, although lesser and greater thicknesses may also be used. In some embodiments, each unit device may comprise a plurality of connector-side mirror reflectors 160 and a plurality of transition edge couplers 140 arranged along a horizontal direction that is perpendicular to the view plane, i.e., the cut plane, of FIG. 5A. In this embodiment, a resulting optical connector die may provide the function of a plurality of optical connector dies 100A illustrated in FIG. 1B or in FIG. 4B. Each connector-side mirror reflector 160 may have a reflection surface that faces downward at a tilt angle of 45 degrees relative to the vertical direction. The carrier wafer 108 may be any wafer that may be detached at a later processing step.

Referring to FIG. 5B, a first spacer plate 111 may be attached to a top surface of the array of unit devices. The first spacer plate 111 may have the same area as the carrier wafer 108 at this processing step. In one embodiment, the first spacer plate 111 may comprise a dielectric material such as silicon oxide or a transparent polymer material. The thickness of the first spacer plate 111 may be in a range from 10 microns to 300 microns, such as from 20 microns to 150 microns, although lesser and greater thicknesses may also be used.

Referring to FIG. 5C, the carrier wafer 108 may be detached from the array of unit devices. A second spacer plate 112 may be attached to a bottom surface of the array of unit devices. The second spacer plate 112 may have the same area as the first spacer plate 111 at this processing step. In one embodiment, the second spacer plate 112 may comprise a dielectric material such as silicon oxide or a transparent polymer material. The thickness of the second spacer plate 112 may be in a range from 10 microns to 300 microns, such as from 20 microns to 150 microns, although lesser and greater thicknesses may also be used.

Referring to FIG. 5D, the assembly of the array of unit devices, the first spacer plate 111, and the second spacer plate 112 may be diced along dicing channels into a plurality of optical connector dies 100A, which comprise optical connector units 100. Each optical connector die 100A comprises a respective dielectric matrix layer 150 (which is a portion of the dielectric matrix layer 150 formed at the processing steps of FIG. 5A), a respective first spacer plate 111 (which is a portion of the first spacer plate 111 formed at the processing steps of FIG. 5B), and a respective second spacer plate 112 (which is a portion of the second spacer plate 112 formed at the processing steps of FIG. 5C). Each optical connector die 100A comprises at least one connector-side mirror reflector 160 and at least one transition edge coupler 140, and may be used in the embodiment structures of the present disclosure, such as first and second embodiment structures illustrated in FIGS. 1A-1E and 4A-4E, or in embodiment structures to be subsequently described.

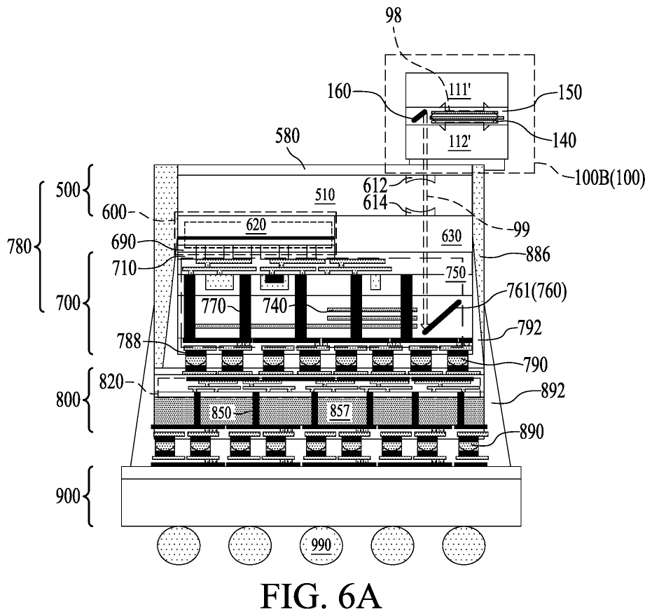

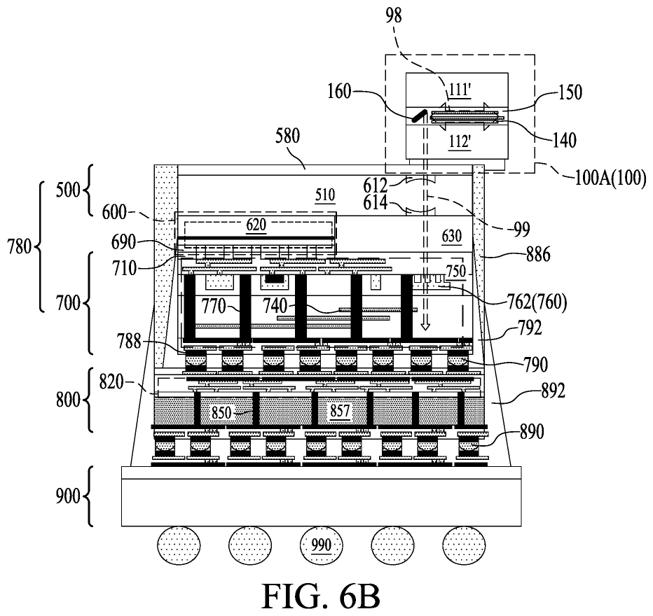

FIG. 6A is a vertical cross-sectional view of a third embodiment structure according to an aspect of the present disclosure. FIG. 6B is a vertical cross-sectional view of an alternative configuration of the third embodiment structure according to an aspect of the present disclosure.

The third embodiment structures illustrated in FIGS. 6A and 6B may be derived from the first embodiment structures illustrated in FIGS. 1A-1E or second embodiments structures illustrated in FIGS. 4A-4E and described above by using an optical connector die 100B (in lieu of optical connector die 100A) using a semiconductor material plate for at least one of the first spacer plate 111 and the second spacer plate 112 illustrated in FIG. 5D. For example, the optical connector die 100B illustrated in FIGS. 6A and 6B may comprise a first spacer plate 111′ comprising, and/or consisting essentially of, a semiconductor material such as silicon, and/or may comprise a second spacer plate 112′ comprising, and/or consisting essentially of, a semiconductor material such as silicon. The thickness of each of the first spacer plate 111′ and the second spacer plate 112′ may be in a range from 10 microns to 300 microns, such as from 20 microns to 150 microns, although lesser and greater thicknesses may also be used. Generally, an encapsulation cover 120 may, or may not, be used over the optical connector die 100B.

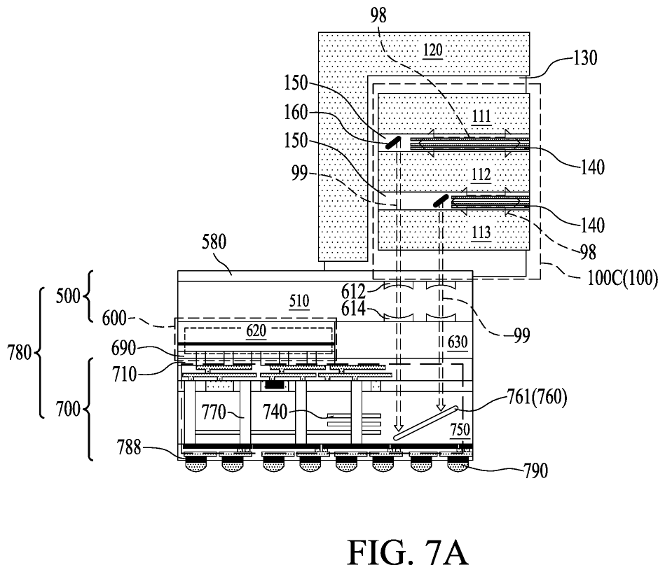

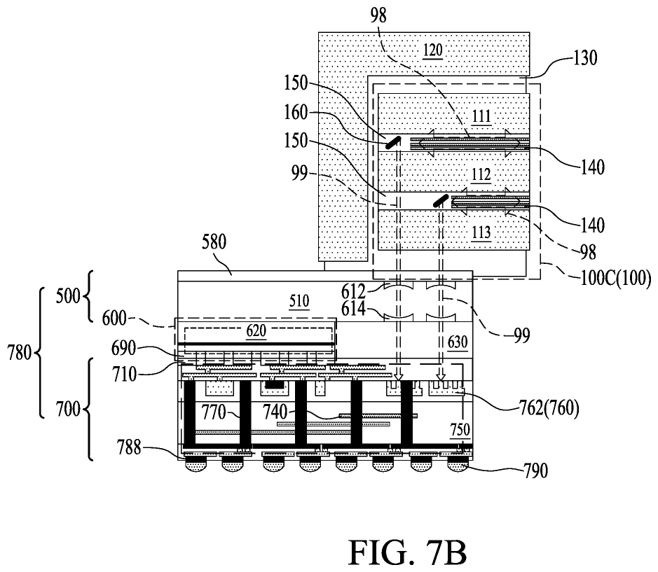

FIG. 7A is a vertical cross-sectional view of a fourth embodiment structure according to an aspect of the present disclosure. FIG. 7B is a vertical cross-sectional view of an alternative configuration of the fourth embodiment structure according to an aspect of the present disclosure.

The fourth embodiment structure illustrated in FIGS. 7A and 7B may be derived from any of the first, second, and third embodiment structures (including any alternative configurations) as illustrated in FIGS. 1A-lE, 4A-4E, 6A, and 6B, by using an optical connector die 100C including multiple connector-side mirror reflectors 160 formed at different levels, i.e., at different distances from the top surface of the composite die 780. In this embodiment, a first connector-side mirror reflector 160 and a first transition edge coupler 140 may be embedded within a first dielectric matrix layer 150, and may be located between, and may be contacted by, a first spacer plate (111, 111′) and a second spacer plate (112, 112′). A second connector-side mirror reflector 160 and a second transition edge coupler 140 may be embedded within a second dielectric matrix layer 150, and may be located between, and may be contacted by, the second spacer plate (112, 112′) and a third spacer plate 113. The third spacer plate 113 may have the same material composition and the same thickness range as a first spacer plate (111, 111′).

In one embodiment, the optical connector die 100C may comprise a first connector-side mirror reflector 160 and a first transition edge coupler 140 embedded within a first dielectric matrix layer 150, and a second connector-side mirror reflector 160 and a second transition edge coupler 140 embedded in a second dielectric matrix layer 150 and located at a different vertical distance from the composite die 780 than the first connector-side mirror reflector 160 and the first transition edge coupler 140 are from the composite die 780. In this embodiment, the first connector-side mirror reflector 160 may be located at a top end of a first vertically-extending beam path 99, and the second connector-side mirror reflector 160 may be located at a top end of a second vertically-extending beam path 99 that is laterally offset from the first vertically-extending beam path 99. Thus, the second connector-side mirror reflector 160 is laterally offset from the first connector-side mirror reflector 160. A first horizontally-extending beam path 98 extends through the first transition edge coupler 140, and a second horizontally-extending beam path 98 extends through the second transition edge coupler 140. Thus, the second horizontally-extending beam path 98 is vertically offset from the first horizontally-extending beam path 98. Generally, an encapsulation cover 120 may, or may not, be used over the optical connector die 100C.

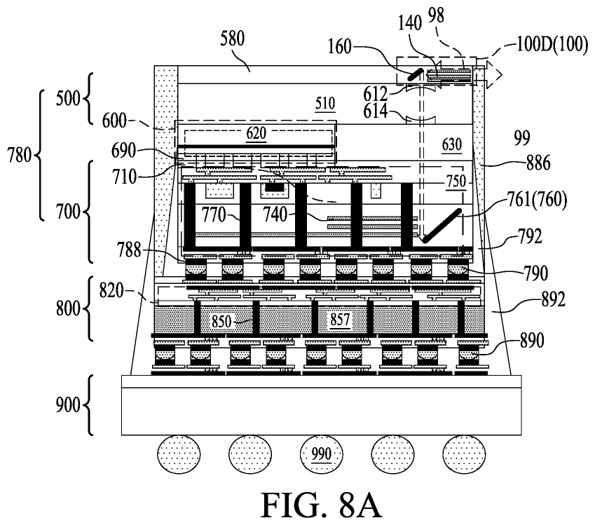

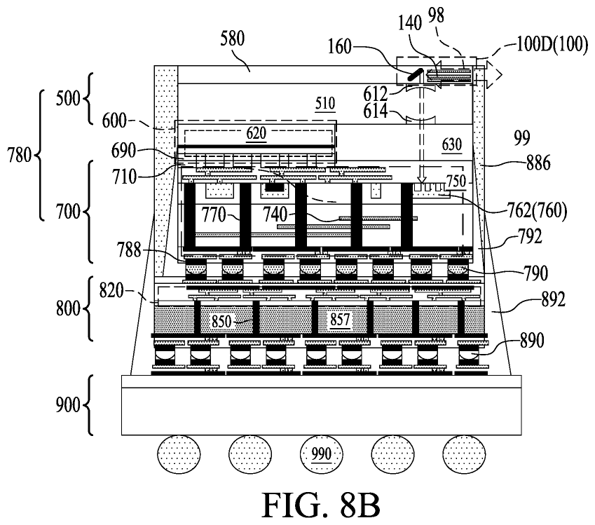

FIG. 8A is a vertical cross-sectional view of a fifth embodiment structure according to an aspect of the present disclosure. FIG. 8B is a vertical cross-sectional view of an alternative configuration of the fifth embodiment structure according to an aspect of the present disclosure.

Referring to FIGS. 8A and 8B, the fifth embodiment structure comprises an embedded optical connector unit 100D as an optical connector unit 100. The embedded optical connector unit 100D is formed within a portion of the optically transparent dielectric layer 580. The embedded optical connector unit 100D comprises a first connector-side mirror reflector 160 and a first transition edge coupler 140 that are embedded within the optically transparent dielectric layer 580. The first connector-side mirror reflector 160 and the first transition edge coupler 140 are formed within the optically transparent dielectric layer 580 over the support semiconductor substrate 510. Thus, the embedded optical connector unit 100D is formed within the composite die 780. The first connector-side mirror reflector 160 is configured to change a beam direction between a vertically-extending beam path 99 through the composite die 780 and a horizontally-extending beam path 98 through the first transition edge coupler 140. Generally, the composite die 780 comprises a dielectric layer (such as the optically transparent dielectric layer 580) overlying a top surface of the support semiconductor substrate 510, and the optical connector unit 100 (comprising the embedded optical connector unit 100D) may be formed within the optically transparent dielectric layer 580.

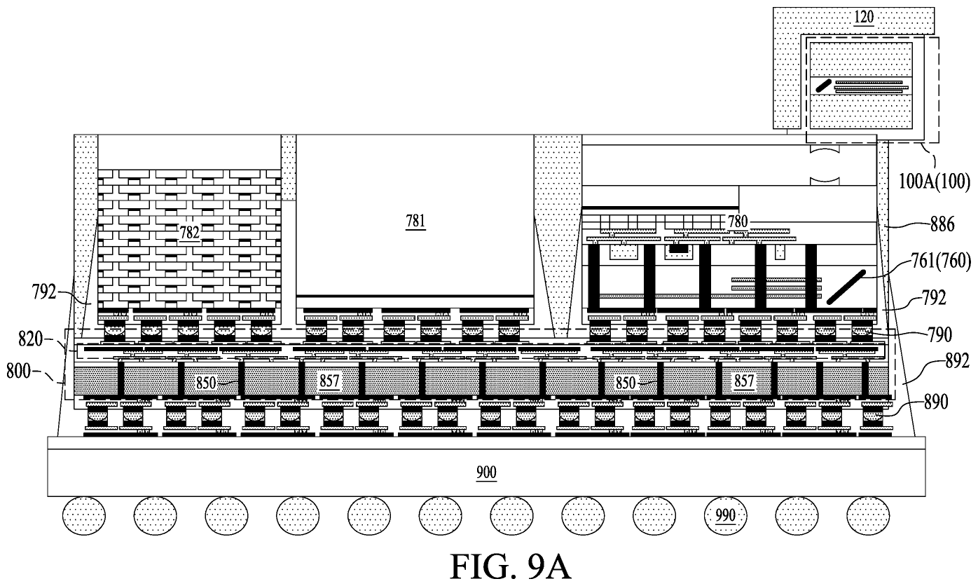

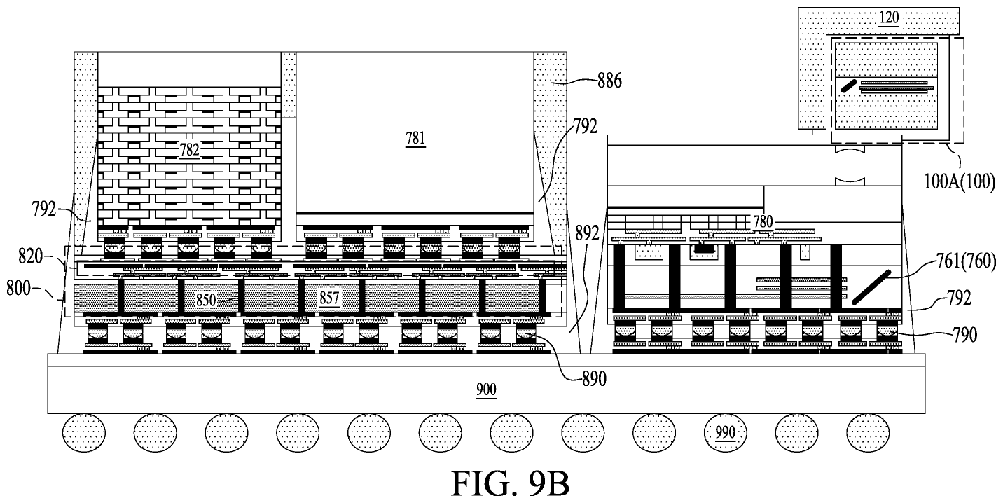

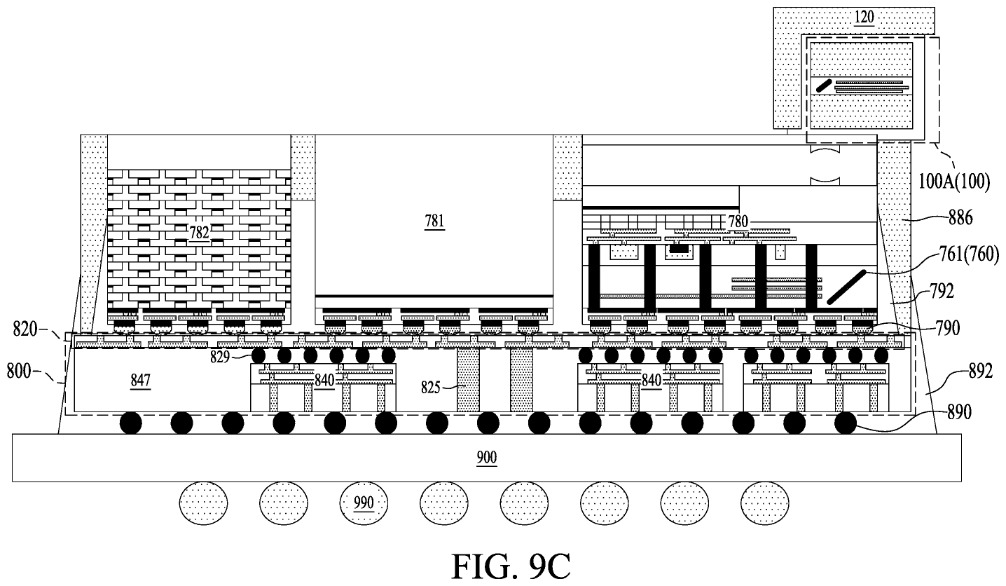

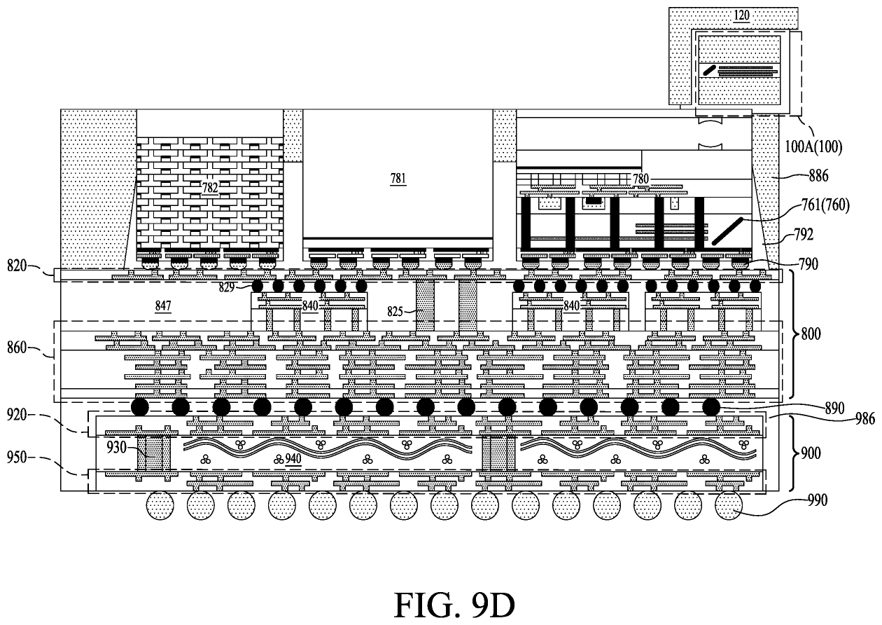

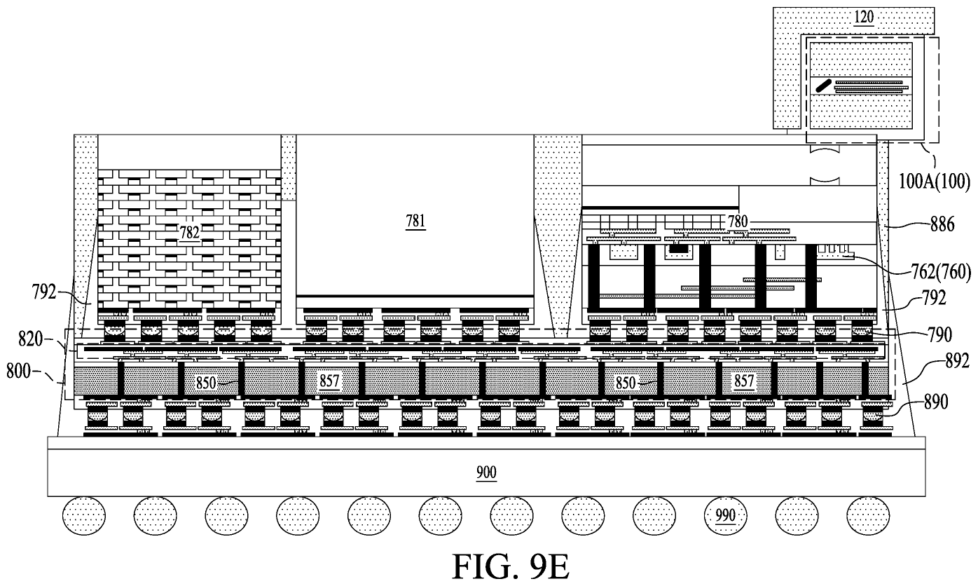

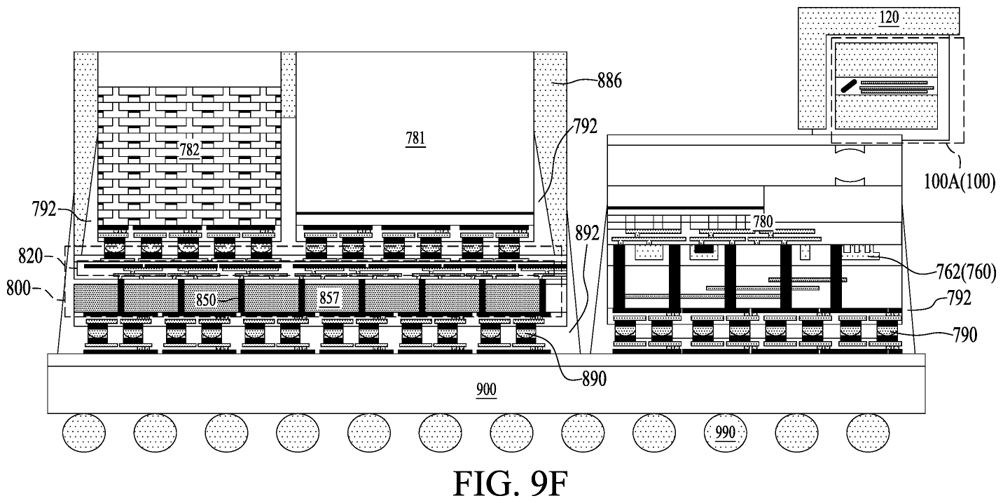

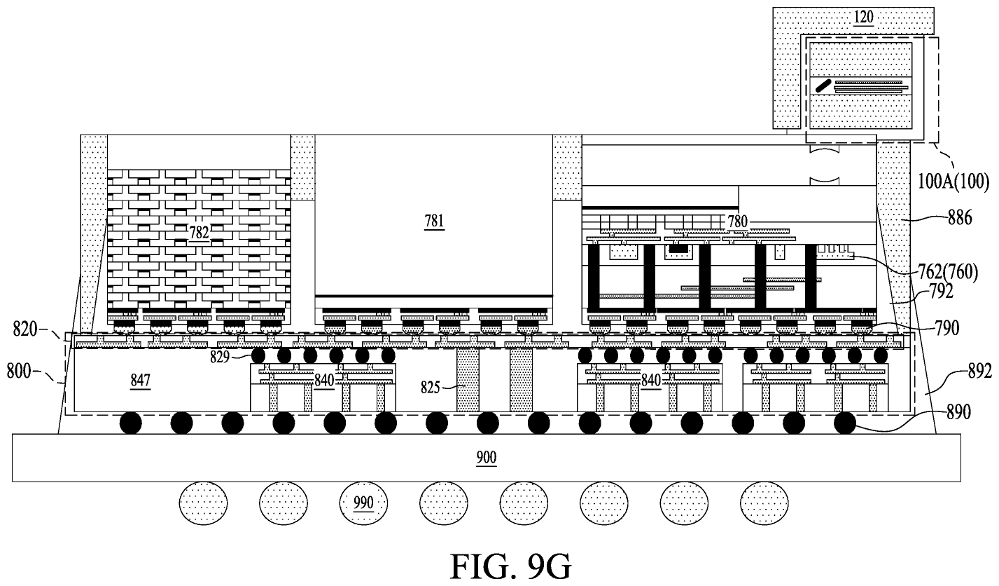

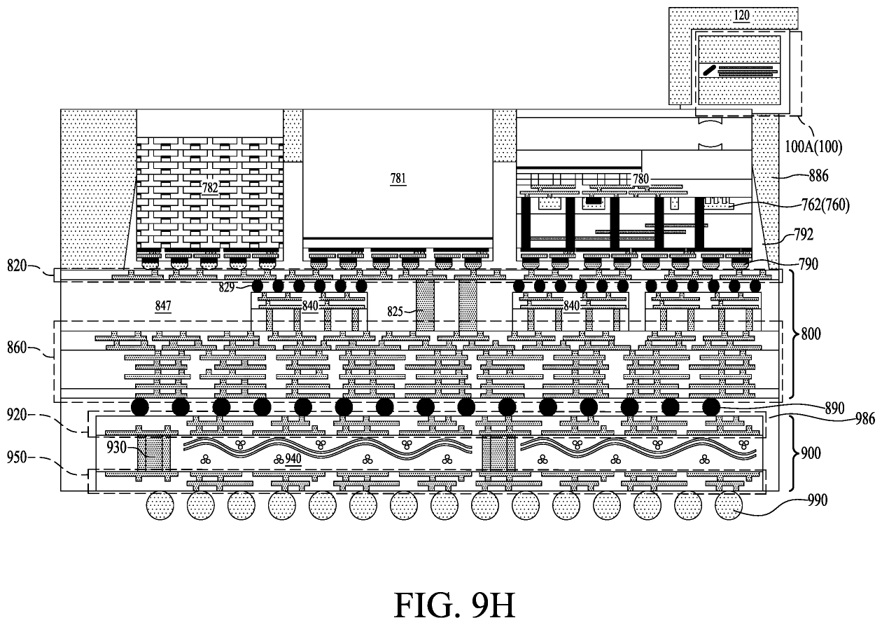

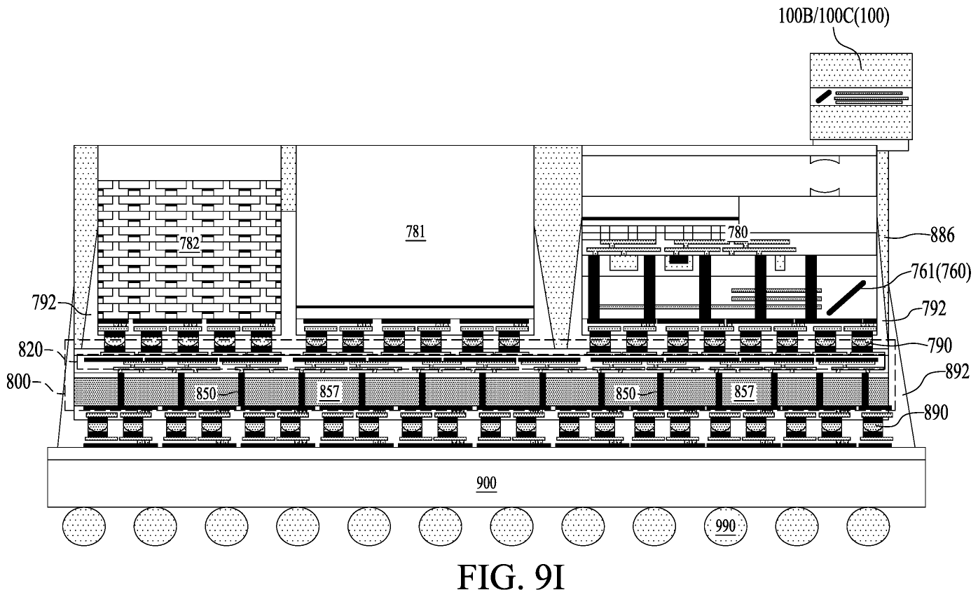

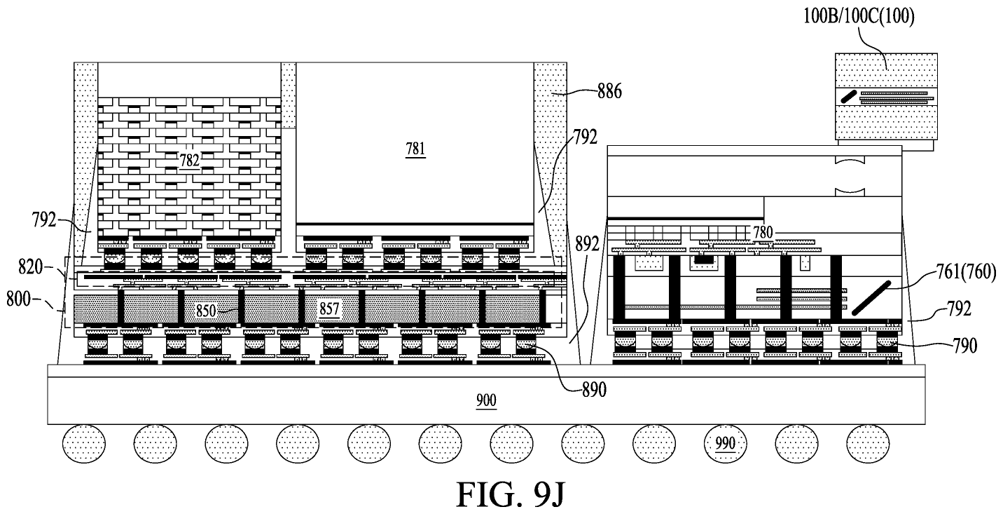

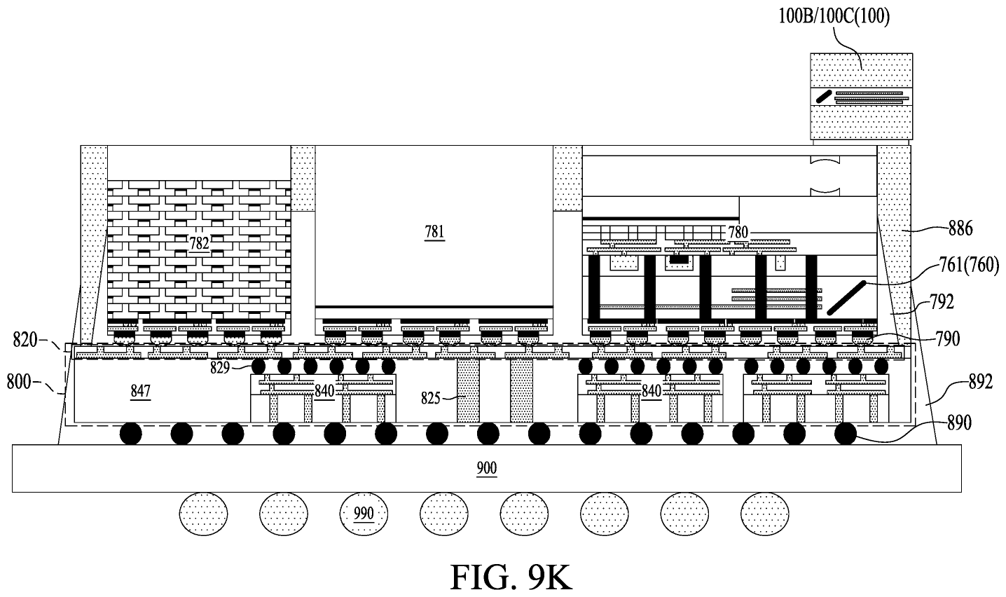

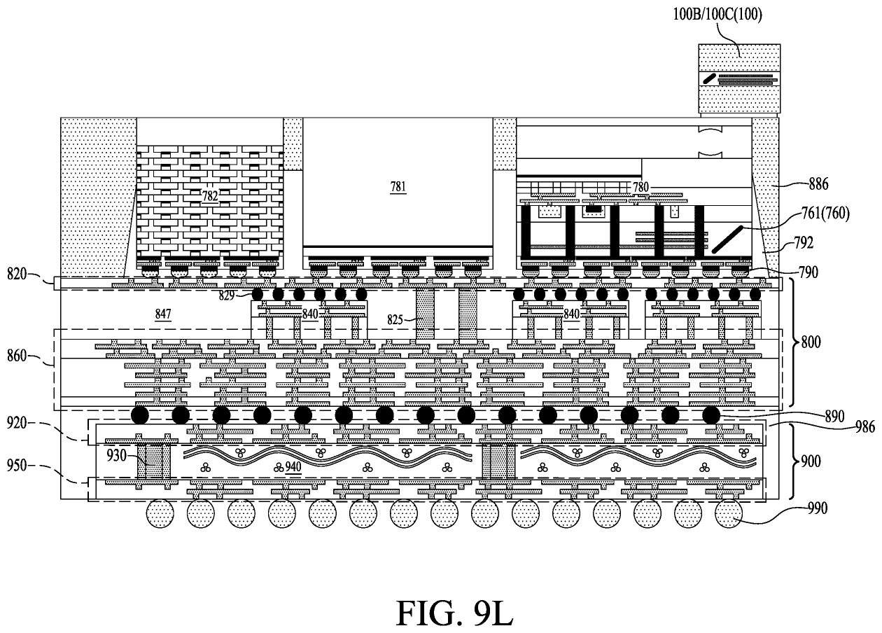

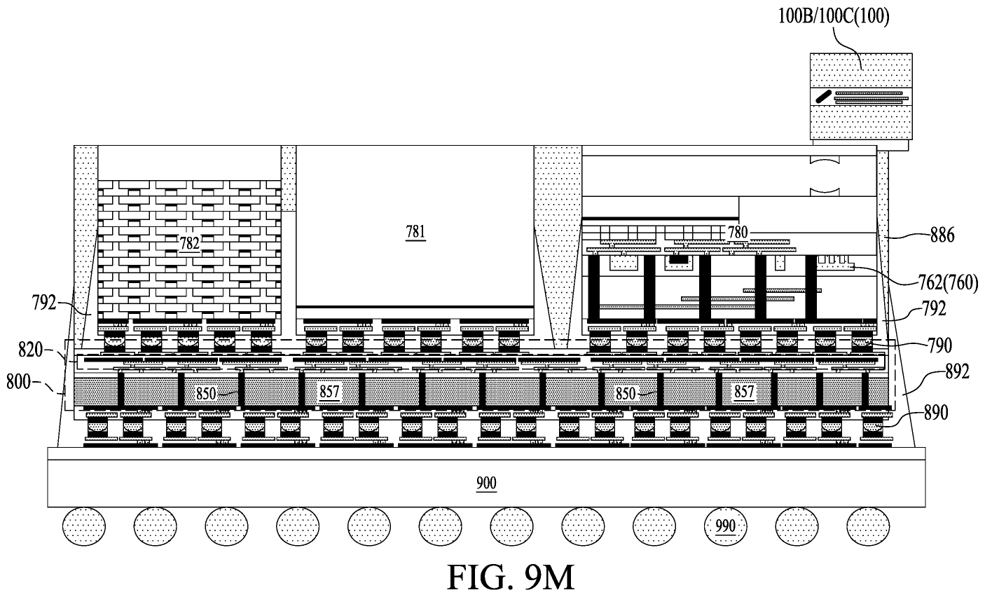

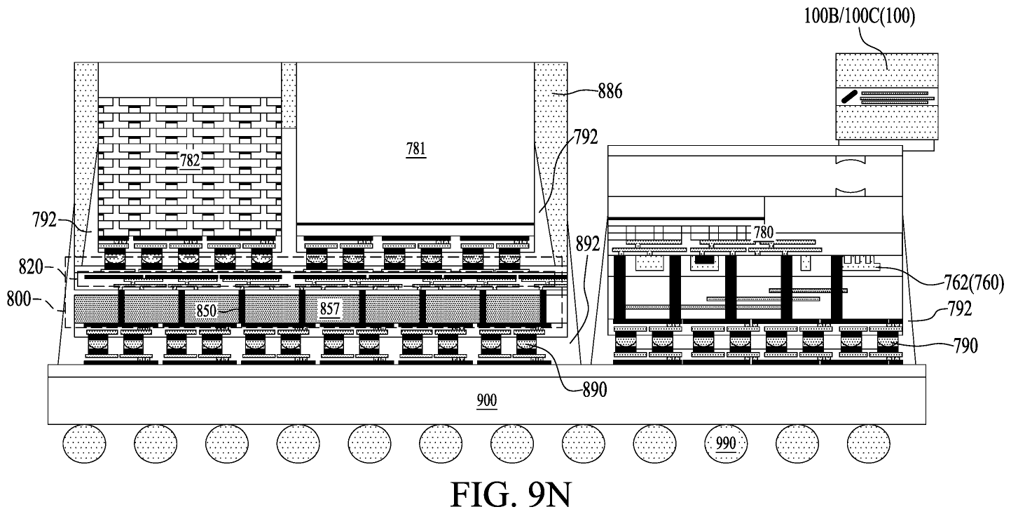

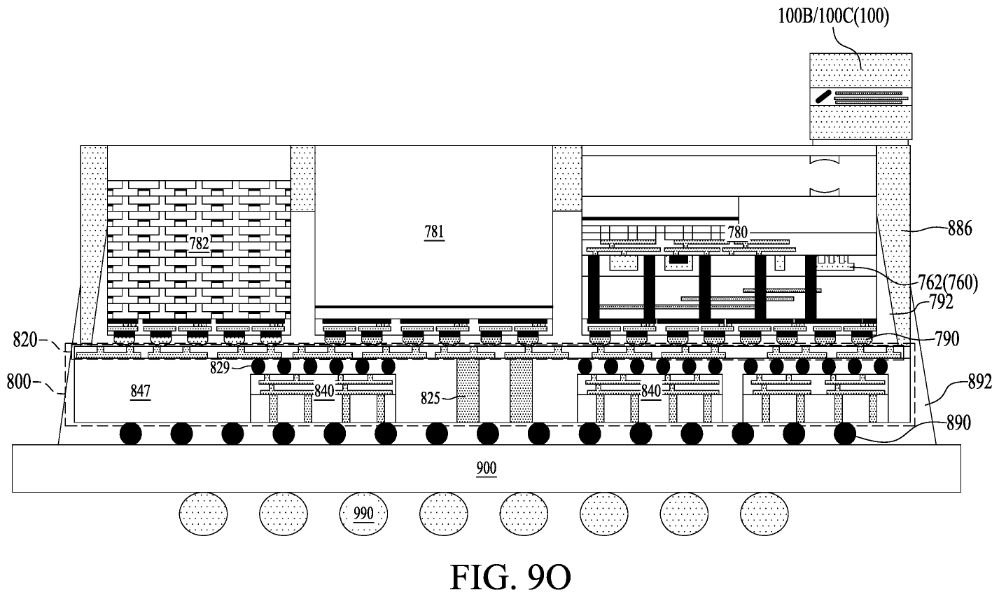

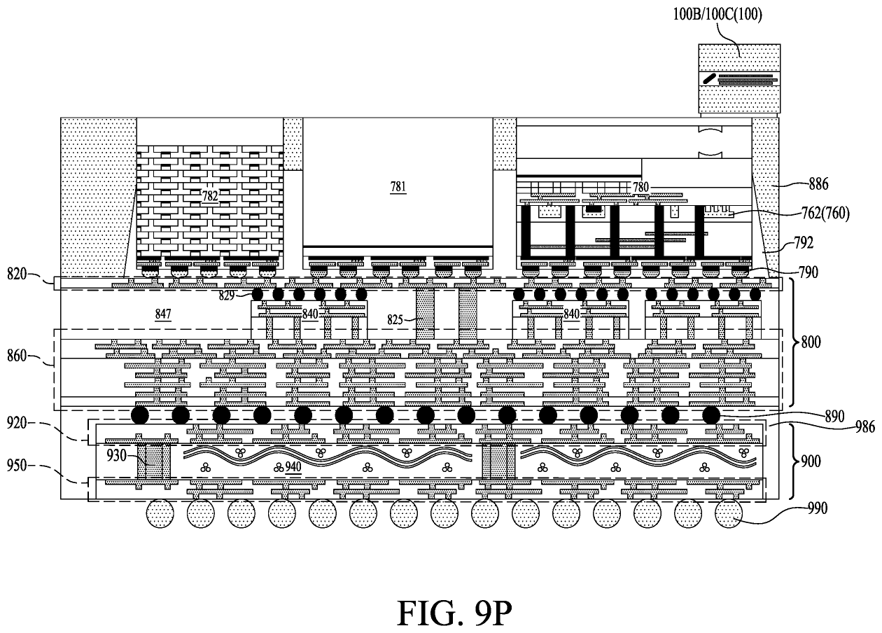

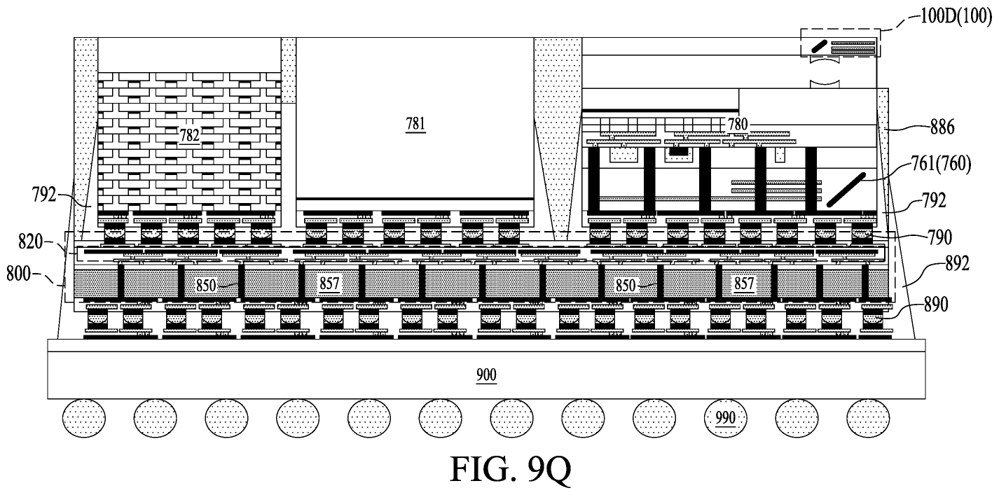

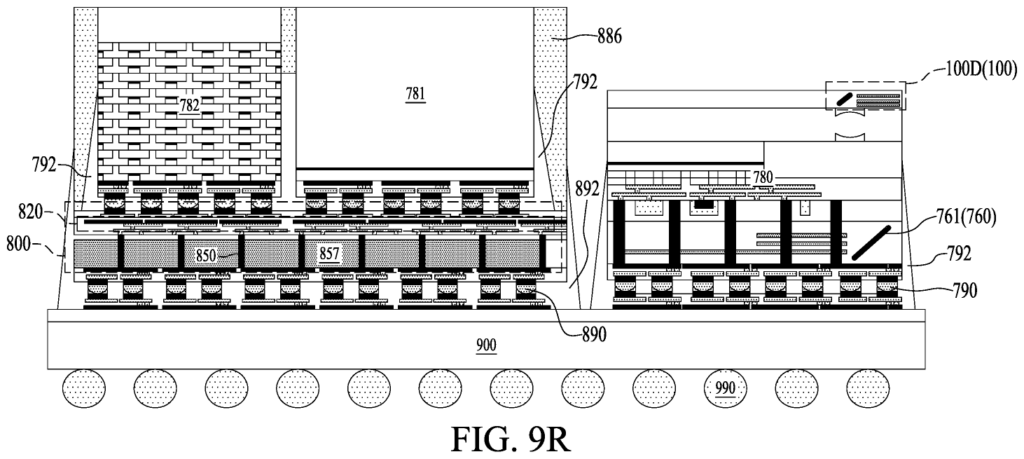

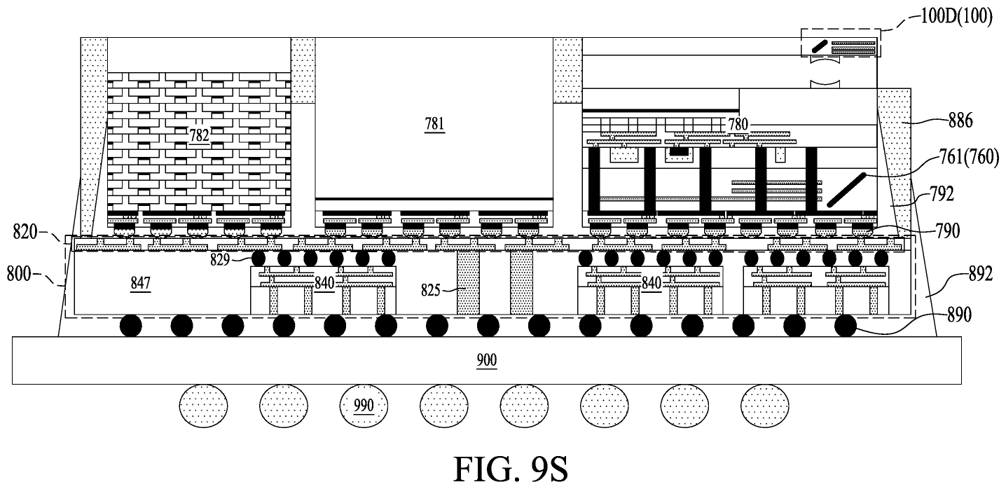

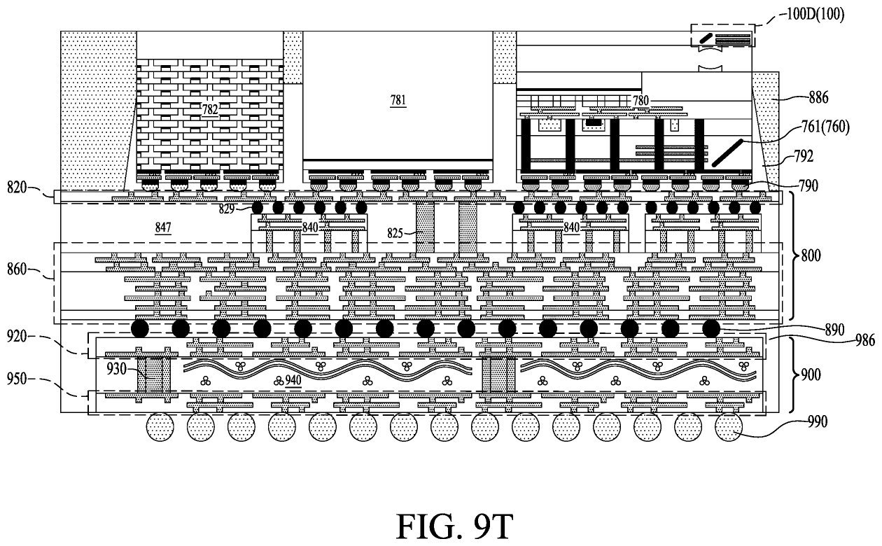

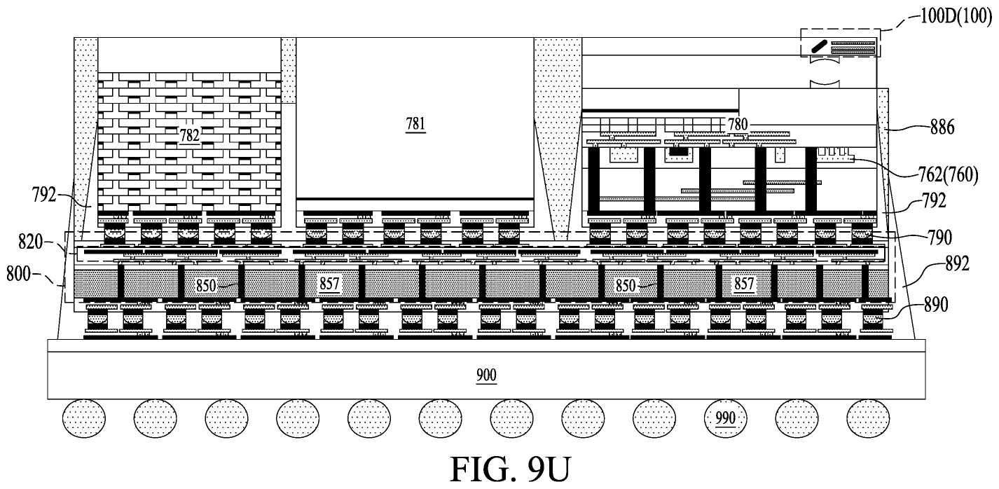

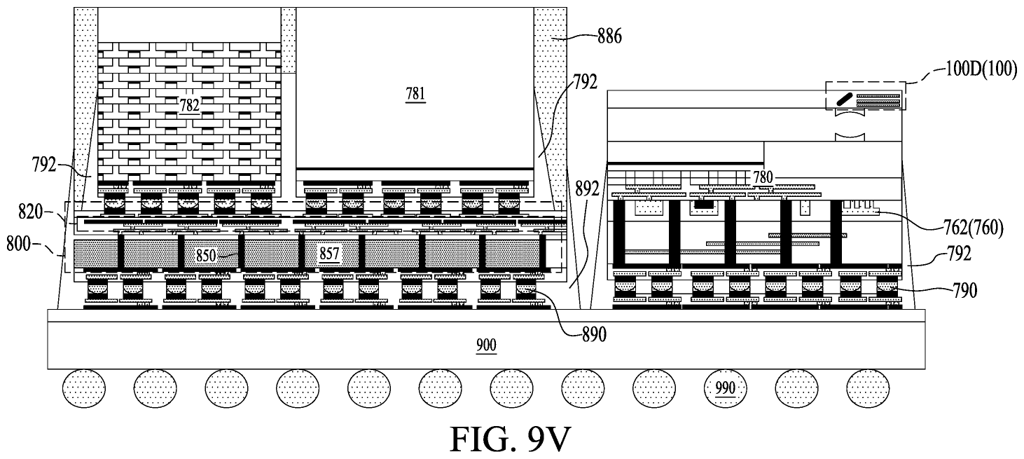

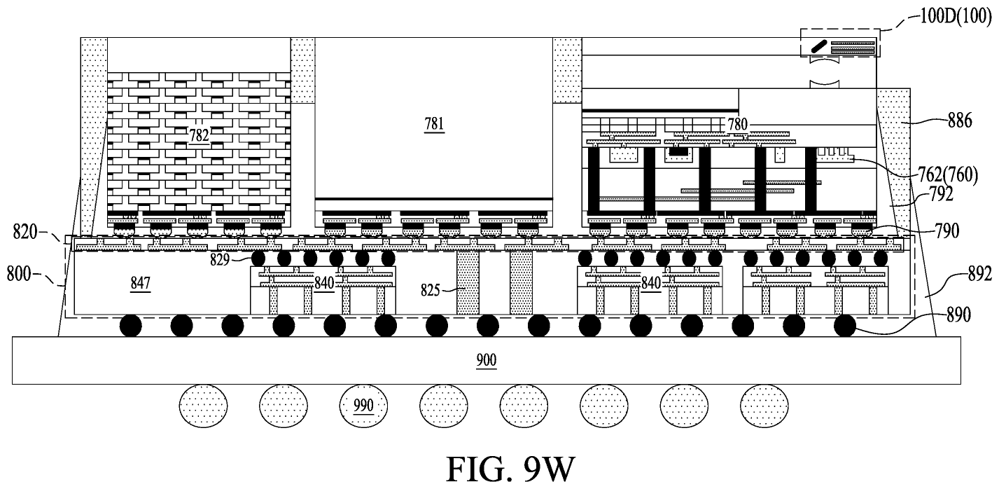

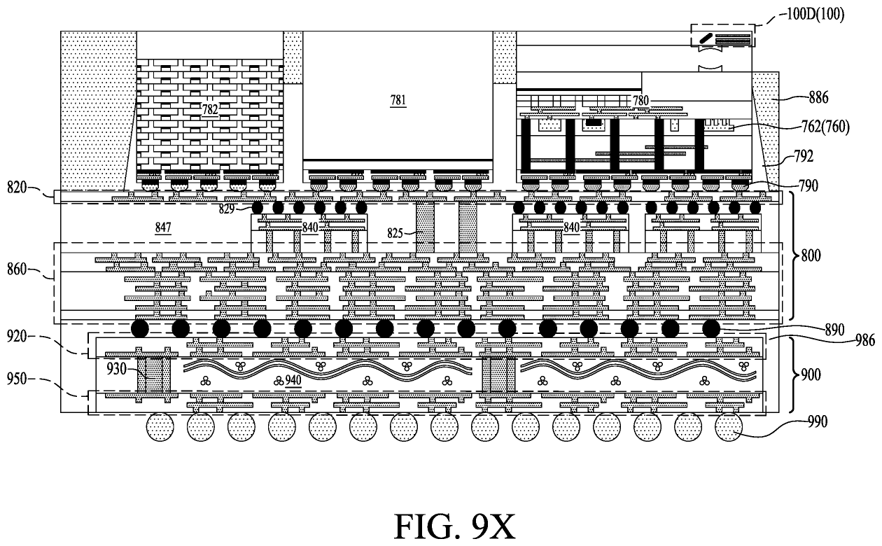

FIGS. 9A-9X are vertical cross-sectional views of various configurations of a sixth embodiment structure according to an aspect of the present disclosure.

Referring to FIG. 9A, a first configuration of the sixth embodiment structure may be derived from the first embodiment structure illustrated in FIGS. 1A-1E by using an interposer 800 having a greater lateral extent than the composite die 780, and by attaching additional semiconductor dies (781, 782) such as an application-specific integrated circuit (ASIC) die 781 and a memory die 782 to the interposer 800 through additional arrays of first solder material portions 790. In one embodiment, an additional first underfill material portion 792 may be formed around the additional semiconductor dies (781, 782), and the molding compound die frame 886 may laterally surround the composite die 780 and the additional semiconductor dies (781, 782). Sidewalls of the molding compound die frame 886 may be vertically coincident with sidewalls of the interposer 800. The optical connector unit 100 may be attached to the composite die 780 prior to, or after, attaching the solder joints 990 to the packaging substrate 900. The optical connector unit 100 may be attached to the composite die 780 prior to, or after, attaching solder joints 990 to the packaging substrate 900.

Referring to FIG. 9B, a second configuration of the sixth embodiment structure may be derived form the first embodiment structure illustrated in FIGS. 1A-1E by using a packaging substrate 900 having a greater lateral extent than the composite die 780, by attaching the composite die 780 to the packaging substrate 900 by using an array of first solder material portions 790, and by forming a first underfill material portion around the array of first solder material portions 790. Additional semiconductor dies (781, 782) such as an application-specific integrated circuit (ASIC) die 781 and a memory die 782 may be attached to an interposer 800 through additional arrays of first solder material portions 790. In one embodiment, an additional first underfill material portion 792 may be formed around the additional semiconductor dies (781, 782), and a molding compound die frame 886 may be formed around the additional semiconductor dies (781, 782). Sidewalls of the molding compound die frame 886 may be vertically coincident with sidewalls of the interposer 800. The interposer 800 may be attached to the packaging substrate 900 through an array of second solder material portions 890. A second underfill material portion 892 may be formed around the combination of the additional semiconductor dies (781, 782), the interposer 800, and the molding compound die frame 886. The combination of the additional semiconductor dies (781, 782), the interposer 800, and the molding compound die frame 886 may be located adjacent to the composite die 780 over the packaging substrate 900. The optical connector unit 100 may be attached to the composite die 780 prior to, or after, attaching solder joints 990 to the packaging substrate 900.

Referring to FIG. 9C, a third configuration of the sixth embodiment structure may be derived from the first configuration of the sixth embodiment structure illustrated in FIG. 9A by using a composite interposer including at least one embedded local interconnect die 840 as the interposer 800. In this embodiment, the interposer 800 may comprise at least one embedded local interconnect die 840 (such as silicon interconnect dies including a silicon substrate, through-substrate via structures, and metal interconnect structures embedded in dielectric material layers), through-interposer via structures 825 located adjacent to, and/or between, the at least one embedded local interconnect die 840, an interposer molding compound frame 847 embedding the at least one embedded local interconnect die 840 and the through-interposer via structures 825, and metal interconnect wiring 820 that is electrically connected to the at least one embedded local interconnect dies 840 through microbump structures 829 and eclectically connected to the through-interposer via structures 825. The composite die 780 and the additional semiconductor dies (781, 782) may be attached to the interposer 800 through a respective array of first solder material portions 790. A first underfill material portion 792 may laterally surround the arrays of first solder material portions 790. A molding compound die frame 886 may laterally surround composite die 780 and the additional semiconductor dies (781, 782). Sidewalls of the molding compound die frame 886 may be vertically coincident with sidewalls of the interposer 800. The assembly of the interposer 800, the composite die 780, the additional semiconductor dies (781, 782), and the molding compound die frame 886 may be attached to the packaging substrate 900 through an array of second solder material portions 890. A second underfill material portion 892 may laterally surround the array of second solder material portions 890. The optical connector unit 100 may be attached to the composite die 780 prior to, or after, attaching solder joints 990 to the packaging substrate 900.

Referring to FIG. 9D, a fourth configuration of the sixth embodiment structure may be derived from the third configuration of the sixth embodiment structure illustrated in FIG. 9C by using a composite interposer including additional metal interconnect wiring 860 as the interposer 800. In this embodiment, the interposer 800 may comprise at least one embedded local interconnect die 840 (such as silicon interconnect dies including a silicon substrate, through-substrate via structures, and metal interconnect structures embedded in dielectric material layers), through-interposer via structures 825 located adjacent to, and/or between, the at least one embedded local interconnect die 840, an interposer molding compound frame 847 embedding the at least one embedded local interconnect die 840 and the through-interposer via structures 825, die-side metal interconnect wiring 820 that is electrically connected to the at least one embedded local interconnect dies 840 through microbump structures 829 and eclectically connected to the through-interposer via structures 825, and package-side metal interconnect wiring 860 located on an opposite side of the die-side metal interconnect wiring 820.

The composite die 780 and the additional semiconductor dies (781, 782) may be attached to the interposer 800 through a respective array of first solder material portions 790. A first underfill material portion 792 may laterally surround the arrays of first solder material portions 790. A molding compound die frame 886 may laterally surround composite die 780 and the additional semiconductor dies (781, 782). Sidewalls of the molding compound die frame 886 may be vertically coincident with sidewalls of the interposer 800. A wafer including a two-dimensional array of interposers 800 may be provided, and a set of a composite die 780 and additional semiconductor dies (781, 782) may be attached to each interposer 800. A first underfill material portion 792 may be formed around each set of a composite die 780 and additional semiconductor dies (781, 782) that is formed over an interposer 800 within the two-dimensional array of interposer 800. A first molding compound material may be formed over the wafer including the two-dimensional array of interposer 800, and may be planarized to form a first molding compound matrix.

Packaging substrates 900 may be attached to a respective one of the interposers 800 through a respective array of second solder material portions 890. Each packaging substrate 900 may have a lesser area than the interposer 800 to which the packaging substrate 900 is attached. Each packaging substrate 900 may comprise die-side interconnection traces 920 located on a die side and board-side interconnection traces 950 located on a board side. Further, each packaging substrate 900 may comprise through-substrate via structures 930 embedded within an insulating substrate 940 and providing electrical connection between the die-side interconnection traces 920 and the board-side interconnection traces 950. A second molding compound material may be formed under the wafer including the two-dimensional array of interposer 800, and may be planarized to form a second molding compound matrix.

The combination of the wafer, a two-dimensional array of sets of dies (780, 781, 782), a two-dimensional array of packaging substrates 900, the first molding compound matrix, and the second molding compound matrix may be diced along dicing channels to form photonic assemblies. Each photonic assembly comprises a composite die 780, additional semiconductor dies (781, 782), a first underfill material portion 792, a molding compound die frame 886 that is a diced portion of the first molding compound matrix, a packaging substrate 900, and a molding compound substrate frame 986 which is a diced portion of the second molding compound matrix. The optical connector unit 100 may be attached to the composite die 780 prior to, or after, attaching solder joints 990 to the packaging substrate 900.

Referring to FIG. 9E, a fifth configuration of the sixth embodiment structure may be derived from the first configuration of the sixth embodiment structure illustrated in FIG. 9A by using a PIC die 700 illustrated in FIGS. 4A-4E in lieu of the PIC die 700 illustrated in FIGS. 1A-1E. In this embodiment, a grating coupler 762 may be used in lieu of an in-die mirror 761 as the optical deflector 760 in the PIC die 700.

Referring to FIG. 9F, a sixth configuration of the sixth embodiment structure may be derived from the second configuration of the sixth embodiment structure illustrated in FIG. 9B by using a PIC die 700 illustrated in FIGS. 4A-4E in lieu of the PIC die 700 illustrated in FIGS. 1A-1E. In this embodiment, a grating coupler 762 may be used in lieu of an in-die mirror 761 as the optical deflector 760 in the PIC die 700.

Referring to FIG. 9G, a seventh configuration of the sixth embodiment structure may be derived from the third configuration of the sixth embodiment structure illustrated in FIG. 9C by using a PIC die 700 illustrated in FIGS. 4A-4E in lieu of the PIC die 700 illustrated in FIGS. 1A-1E. In this embodiment, a grating coupler 762 may be used in lieu of an in-die mirror 761 as the optical deflector 760 in the PIC die 700.

Referring to FIG. 9H, an eighth configuration of the sixth embodiment structure may be derived from the fourth configuration of the sixth embodiment structure illustrated in FIG. 9D by using a PIC die 700 illustrated in FIGS. 4A-4E in lieu of the PIC die 700 illustrated in FIGS. 1A-1E. In this embodiment, a grating coupler 762 may be used in lieu of an in-die mirror 761 as the optical deflector 760 in the PIC die 700.

Referring to FIG. 9I, a ninth configuration of the sixth embodiment structure may be derived from the first configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9J, a tenth configuration of the sixth embodiment structure may be derived from the second configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9K, an eleventh configuration of the sixth embodiment structure may be derived from the third configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9L, a twelfth configuration of the sixth embodiment structure may be derived from the fourth configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9M, a thirteenth configuration of the sixth embodiment structure may be derived from the fifth configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9N, a fourteenth configuration of the sixth embodiment structure may be derived from the sixth configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9O, a fifteenth configuration of the sixth embodiment structure may be derived from the seventh configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9P, a sixteenth configuration of the sixth embodiment structure may be derived from the eighth configuration of the sixth embodiment structure illustrated in FIG. 9A by using an optical connector die 100B illustrated in FIGS. 6A and 6B or by using an optical connector die 100C illustrated in FIG. 7A or 7B in lieu of an optical connector die 100A illustrated in FIGS. 1A-1E.

Referring to FIG. 9Q, a seventeenth configuration of the sixth embodiment structure may be derived from the first configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

Referring to FIG. 9R, an eighteenth configuration of the sixth embodiment structure may be derived from the second configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

Referring to FIG. 9S, a nineteenth configuration of the sixth embodiment structure may be derived from the third configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

Referring to FIG. 9T, a twentieth configuration of the sixth embodiment structure may be derived from the fourth configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

Referring to FIG. 9U, a twenty-first configuration of the sixth embodiment structure may be derived from the fifth configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

Referring to FIG. 9V, a twenty-second configuration of the sixth embodiment structure may be derived from the sixth configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

Referring to FIG. 9W, a twenty-third configuration of the sixth embodiment structure may be derived from the seventh configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

Referring to FIG. 9X, a twenty-fourth configuration of the sixth embodiment structure may be derived from the eighth configuration of the sixth embodiment structure illustrated in FIG. 9A by using an embedded optical connector unit 100D illustrated in FIGS. 8A and 8B in lieu of an optical connector die 100A illustrated in FIGS. 1A-1E.

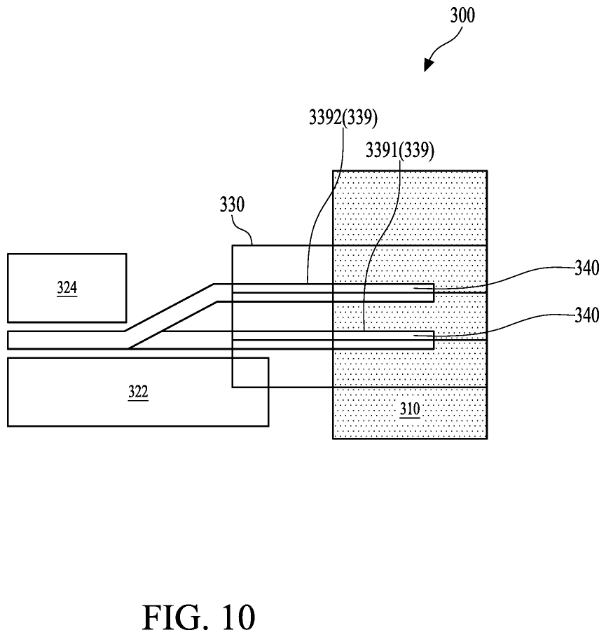

Referring to FIG. 10, a fiber array units assembly 300 according to an aspect of the present disclosure is illustrated, which may be used in conjunction with any of the embodiment structures above to provide optical coupling with an optical connector unit 100. The fiber array units assembly 300 comprises a proximal support plate 322, a distal support plate 324 overlying the proximal support plate 322 and having a lesser lateral extent than the proximal support plate 322, and optical fibers 340 located between the proximal support plate 322 and the distal support plate 324.

The spacing between the proximal support plate 322 and the distal support plate 324 may be about the same as the vertical dimension of a transition edge coupler 140 in an optical connector unit 100 described above, and may be about the same as the thickness of a dielectric matrix layer 150. The lateral dimension of the proximal support plate 322 may be in a range from 60 microns to 1 mm, such as from 120 microns to 500 microns, although lesser and greater lateral dimensions may also be used. The lateral dimension of the distal support plate 324 may be in a range from 30 microns to 500 microns, such as from 60 microns to 250 microns, although lesser and greater lateral dimensions may also be used.

In one embodiment, the proximal support plate 322 may comprise a stiff material such as a silicon. The thickness of the proximal support plate 322 may be in a range from 30 microns to 300 microns, such as from 60 microns to 150 microns, although lesser and greater thicknesses may also be used. The distal support plate 324 may comprise an optically transparent material such as silicon oxide. The thickness of the distal support plate 324 may be in a range from 10 microns to 300 microns, such as from 20 microns to 150 microns, although lesser and greater thicknesses may also be used. In some embodiments, the thickness of the distal support plate 324 may be the same as the thickness of the first spacer plate 111.

In one embodiment, the fiber array units assembly 300 comprises a fiber array matrix 310, which is a block of a rigid material including a plurality of laterally-extending cavities therein and/or therethrough. Each of the plurality of laterally-extending cavities may have a respective widthwise dimension (such as a diameter) that is the same as the diameter of an optical fiber 340, and may be configured to fit in a respective optical fiber 340. The laterally-extending cavities in the fiber array matrix 310 is herein referred to as a fiber sheath 339. The fiber sheaths 339 may be arranged as a rectangular array or as a hexagonal array including at least two vertically stacked rows of fiber sheaths 339. Each of the optical fibers 340 may comprise a respective first end that is located between the proximal support plate 322 and the distal support plate 324, and a respective second end that is fitted into a respective one of the fiber sheaths 339.

Generally, the fiber sheaths 339 may laterally surround a respective optical fibers 340, and may be laterally spaced from the proximal support plate 322 and the distal support plate 324. In one embodiment, the fiber sheaths 339 comprises first sheaths 3391 and second sheaths 3392 that are vertically spaced from each other; a first subset of the optical fibers 340 extends into the first sheaths 3391; and a second subset of the optical fibers 340 extends into the second sheaths 3392.

The fiber array units assembly 300 may further comprise a fiber cladding 330, which comprises a cladding material and laterally surrounds the portions of the optical fibers 340 that are proximal to the fiber array matrix 310. In one embodiment, the fiber cladding 330 may laterally extend between, and may be adjoined to each of, the fiber array matrix 310 and the proximal support plate 322 without contacting the distal support plate 324. Thus, the optical fibers 340 may be rigidly attached to a transition edge coupler 140 in an optical connector unit 100 during attachment to the optical connector unit 100.

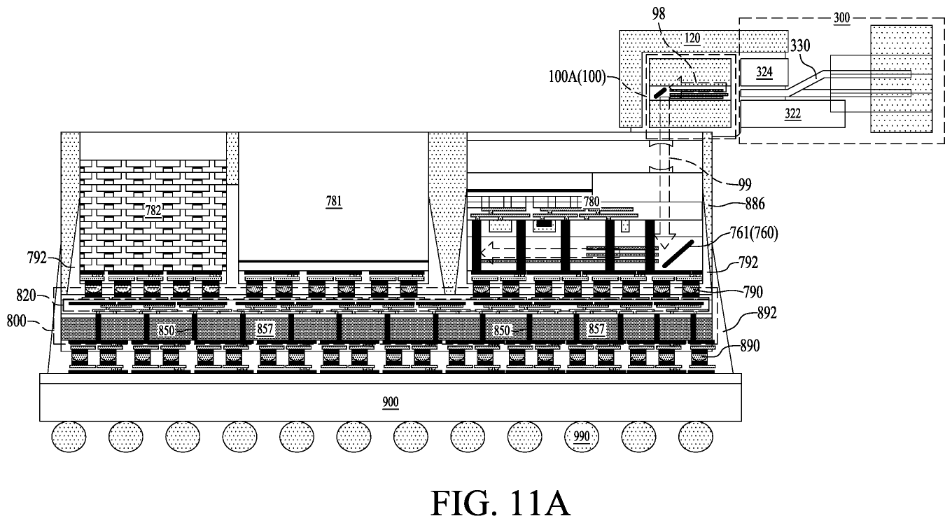

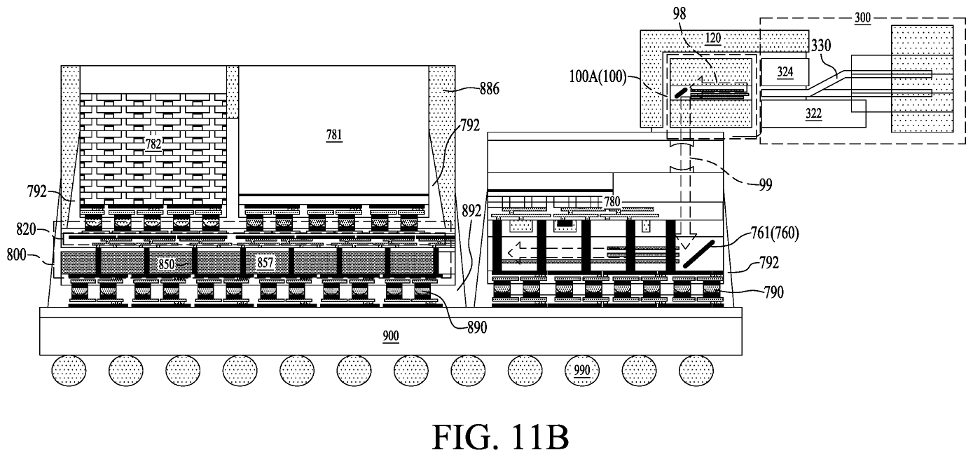

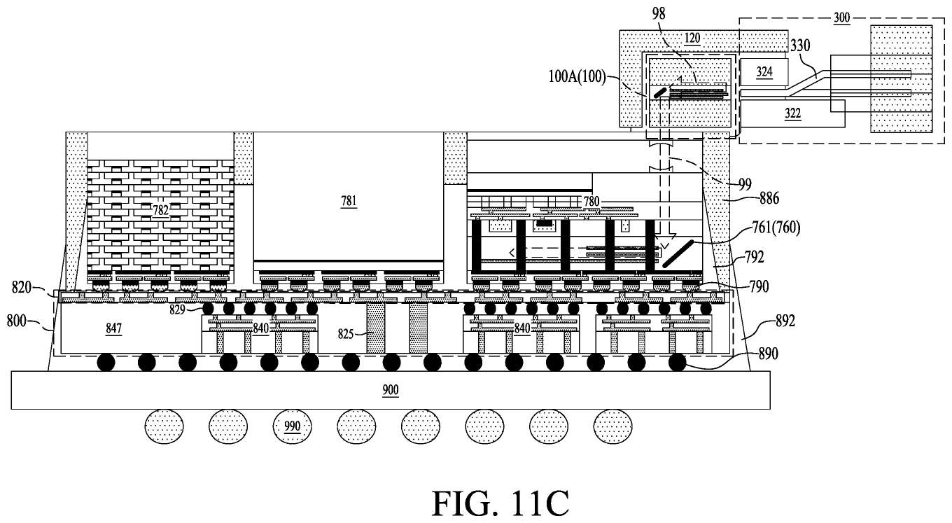

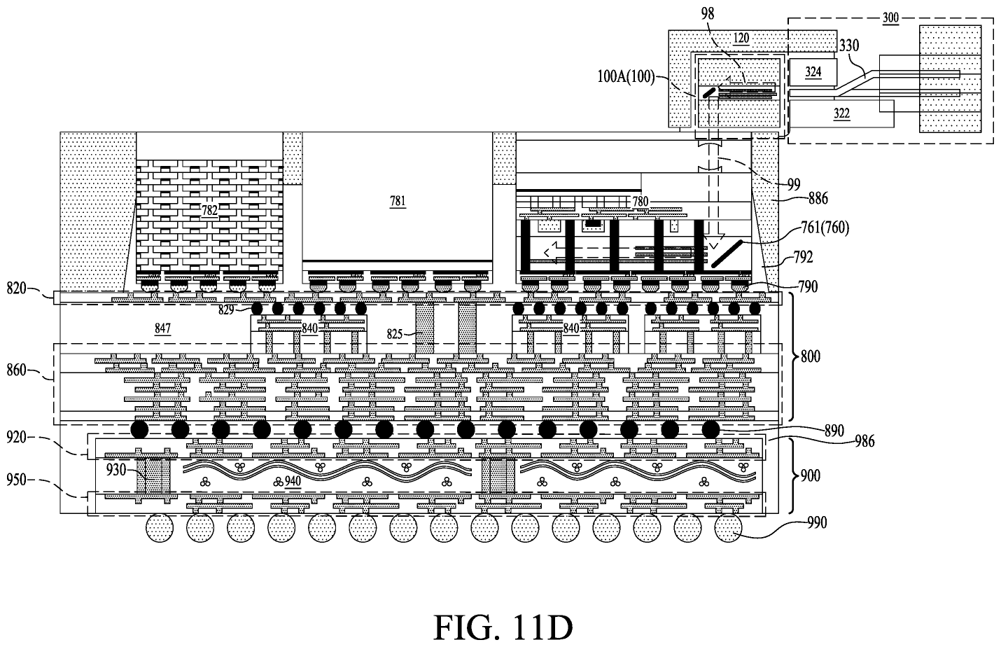

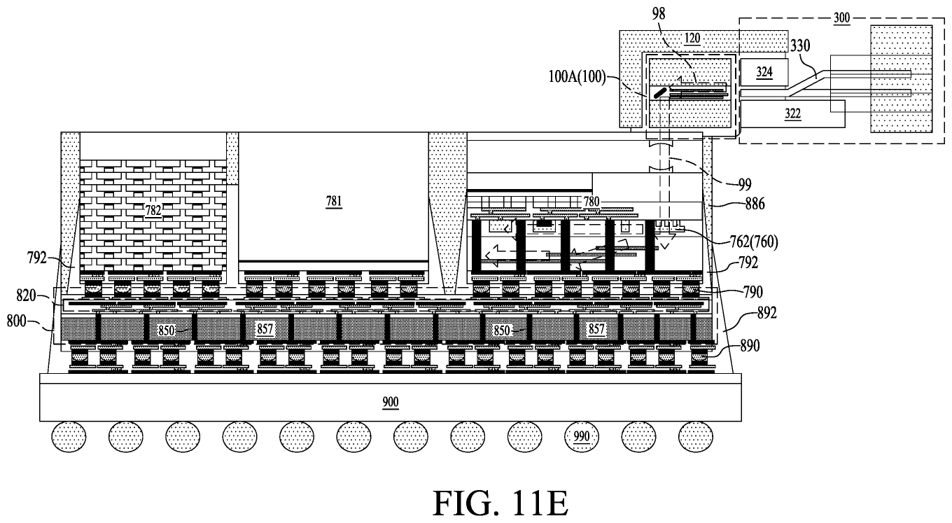

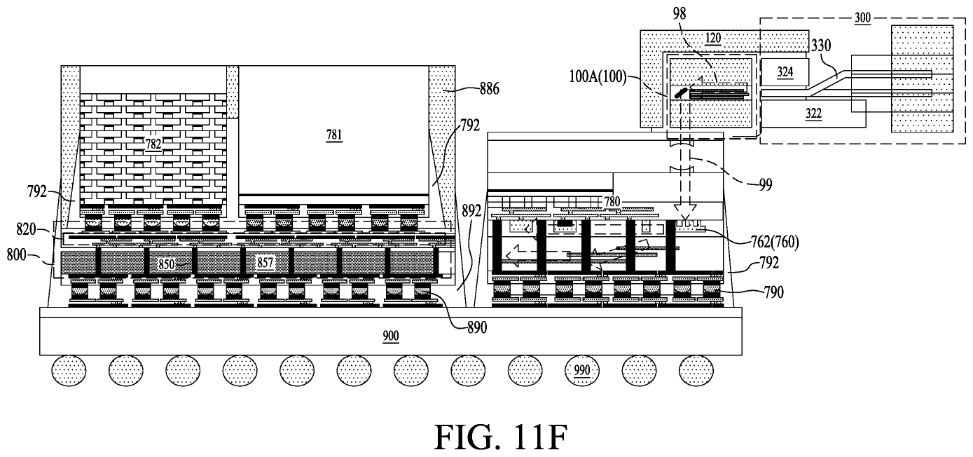

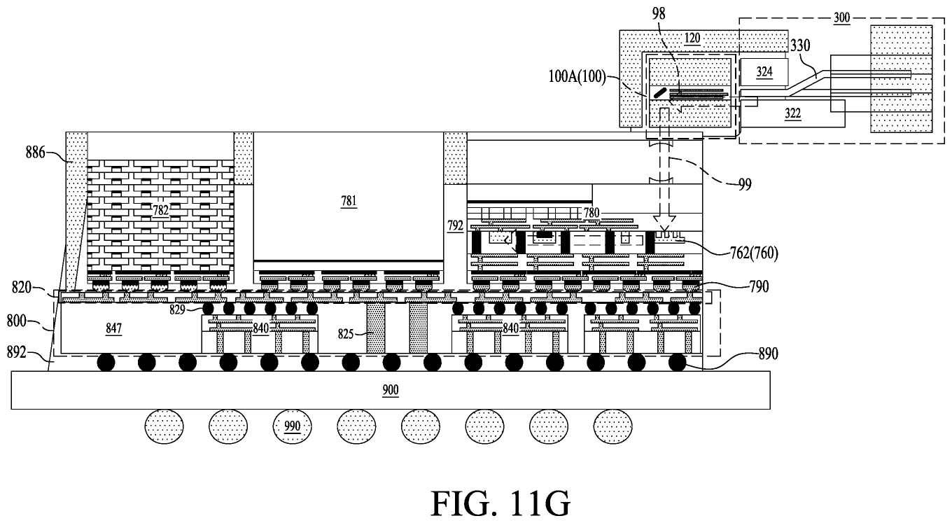

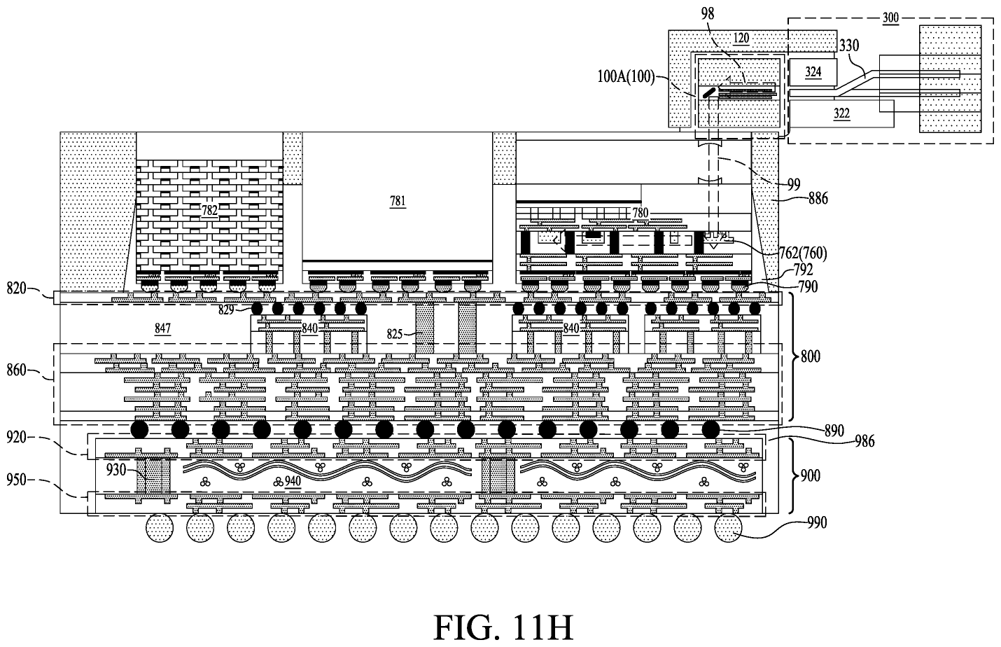

FIGS. 11A-11H are vertical cross-sectional views of various configurations of a seventh embodiment structure according to an aspect of the present disclosure. Generally, the fiber array units assembly 300 illustrated in FIG. 10 may be attached to any of the optical connector units 100 described above. For example, the optical glue portion 130 may be used to attach the fiber array units assembly 300 to any of the optical connector units 100 described above. Further, in embodiments in which an encapsulation cover 120 is present over the optical connector unit 100, the encapsulation cover 120 may be laterally extended to cover the top surface of the distal support plate 324. In this embodiment, the optical glue portion 130 may be applied on the top surface of the distal support plate 324, and may be attached to a bottom surface of a laterally protruding portion of the encapsulation cover 120 through the optical glue portion 130. Generally, the height of the optical fibers 340 may be the same as the height of a transition edge coupler 140 within an optical connector unit 100 so that optical coupling between the transition edge coupler 140 and the optical fibers 340 is maximized.

Generally, a first transition edge coupler 140 may be formed within, or on, the composite die 780. The first connector-side mirror reflector 160 is configured to change a beam direction between a vertically-extending beam path 99 through the composite die 780 and a horizontally-extending beam path 98 through the first transition edge coupler 140. A fiber array units assembly 300 comprising a plurality of optical fibers 340 may be attached to the optical connector unit 100 through an optical glue portion 130. A horizontally-extending beam path 98 laterally extends into a respective optical fiber 340 within a plurality of optical fibers 340.

In some embodiments, the optical connector unit 100 comprises an optical connector die (100A, 100B, 100C) that is attached to a top surface of the composite die 780. In embodiments in which an optical connector die 100C including a plurality of transition edge couplers 140 located at different heights is used, a plurality of fiber array units assemblies 300 located at different heights may be attached to the plurality of transition edge couplers 140. Generally, the proximal support plate 322 and the distal support plate (324, 324′) may be attached to the optical connector die (100A, 100B, 100C) through an optical glue portion 130, and the proximal support plate 322 laterally protrudes farther outward from the optical glue portion 130 than the distal support plate (324, 324′) does from the optical glue portion 130. Alternatively, the optical connector unit 100 may be provided as an embedded optical connector unit 100D illustrated in FIGS. 8A and 8B and FIGS. 9Q-9X. In this embodiment, the fiber array units assembly 300 may be attached to a sidewall of the optically transparent dielectric layer 580 such that the optical fibers 340 are optically coupled to the transition edge coupler 140 embedded within the optically transparent dielectric layer 580.

Referring to FIG. 11A, a first configuration of the seventh embodiment structure may be derived from the first configuration of the sixth embodiment structure illustrated in FIG. 9A, the ninth configuration of the sixth embodiment structure illustrated in FIG. 9I, or the seventeenth configuration of the sixth embodiment structure illustrated in FIG. 9Q by attaching the fiber array units assembly 300 to the optical connector unit 100.

Referring to FIG. 11B, a second configuration of the seventh embodiment structure may be derived from the second configuration of the sixth embodiment structure illustrated in FIG. 9B, the tenth configuration of the sixth embodiment structure illustrated in FIG. 9J, or the eighteenth configuration of the sixth embodiment structure illustrated in FIG. 9R by attaching the fiber array units assembly 300 to the optical connector unit 100.

Referring to FIG. 11C, a third configuration of the seventh embodiment structure may be derived from the third configuration of the sixth embodiment structure illustrated in FIG. 9C, the eleventh configuration of the sixth embodiment structure illustrated in FIG. 9K, or the ninteenth configuration of the sixth embodiment structure illustrated in FIG. 9S by attaching the fiber array units assembly 300 to the optical connector unit 100.

Referring to FIG. 11D, a fourth configuration of the seventh embodiment structure may be derived from the fourth configuration of the sixth embodiment structure illustrated in FIG. 9D, the twelfth configuration of the sixth embodiment structure illustrated in FIG. 9L, or the twentieth configuration of the sixth embodiment structure illustrated in FIG. 9T by attaching the fiber array units assembly 300 to the optical connector unit 100.

Referring to FIG. 11E, a fifth configuration of the seventh embodiment structure may be derived from the fifth configuration of the sixth embodiment structure illustrated in FIG. 9E, the thirteenth configuration of the sixth embodiment structure illustrated in FIG. 9M, or the twenty-first configuration of the sixth embodiment structure illustrated in FIG. 9U by attaching the fiber array units assembly 300 to the optical connector unit 100.

Referring to FIG. 11F, a sixth configuration of the seventh embodiment structure may be derived from the sixth configuration of the sixth embodiment structure illustrated in FIG. 9F, the fourteenth configuration of the sixth embodiment structure illustrated in FIG. 9N, or the twenty-second configuration of the sixth embodiment structure illustrated in FIG. 9V by attaching the fiber array units assembly 300 to the optical connector unit 100.

Referring to FIG. 11G, a seventh configuration of the seventh embodiment structure may be derived from the seventh configuration of the sixth embodiment structure illustrated in FIG. 9F, the fifteenth configuration of the sixth embodiment structure illustrated in FIG. 9N, or the twenty-third configuration of the sixth embodiment structure illustrated in FIG. 9V by attaching the fiber array units assembly 300 to the optical connector unit 100.

Referring to FIG. 11H, an eighth configuration of the seventh embodiment structure may be derived from the eighth configuration of the sixth embodiment structure illustrated in FIG. 9F, the sixteenth configuration of the sixth embodiment structure illustrated in FIG. 9N, or the twenty-fourth configuration of the sixth embodiment structure illustrated in FIG. 9V by attaching the fiber array units assembly 300 to the optical connector unit 100.

Similarly, additional configurations of the seventh embodiment structure may be derived from any of the first through fifth embodiment structures by attaching a fiber array units assembly 300 to the optical connector unit 100.

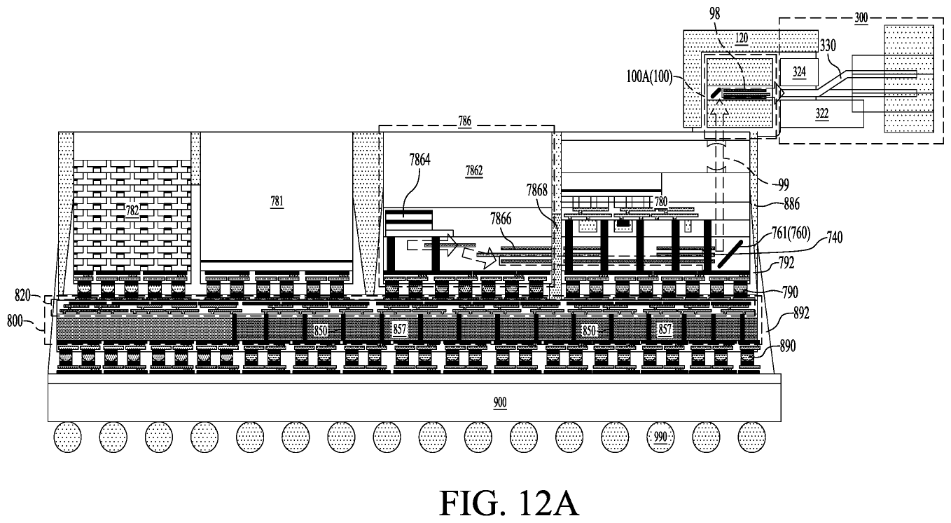

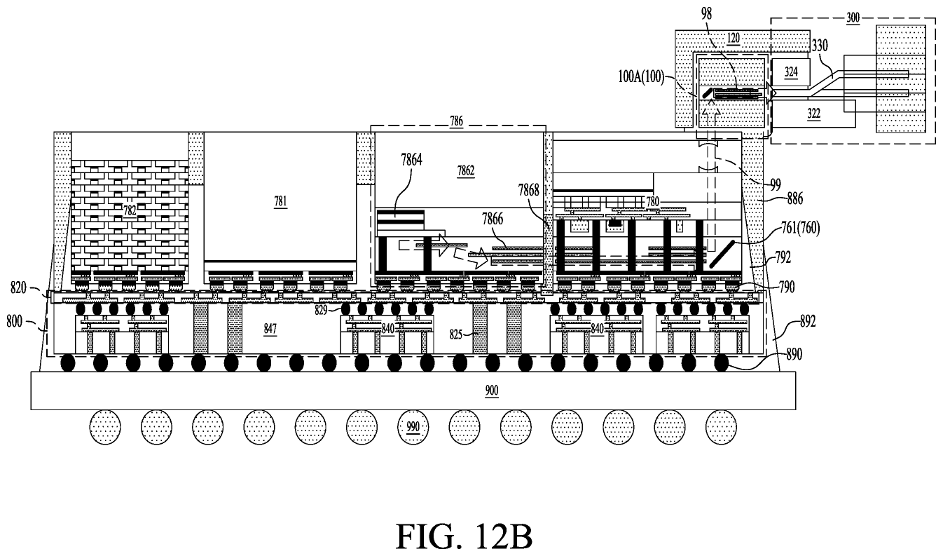

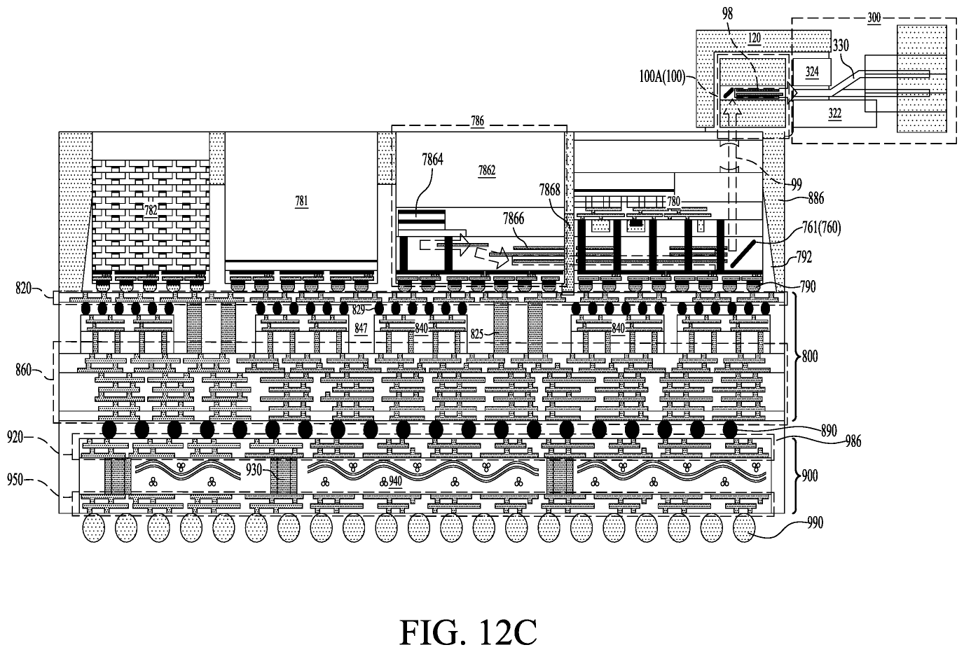

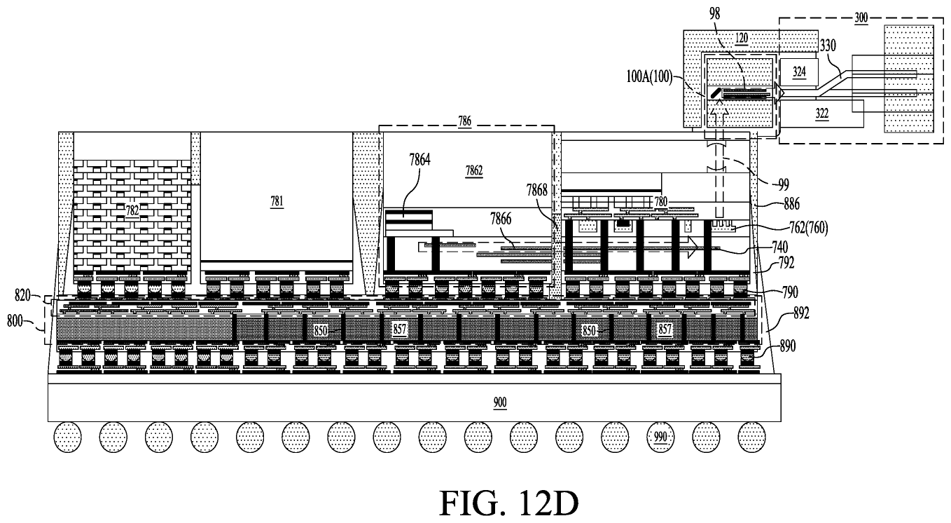

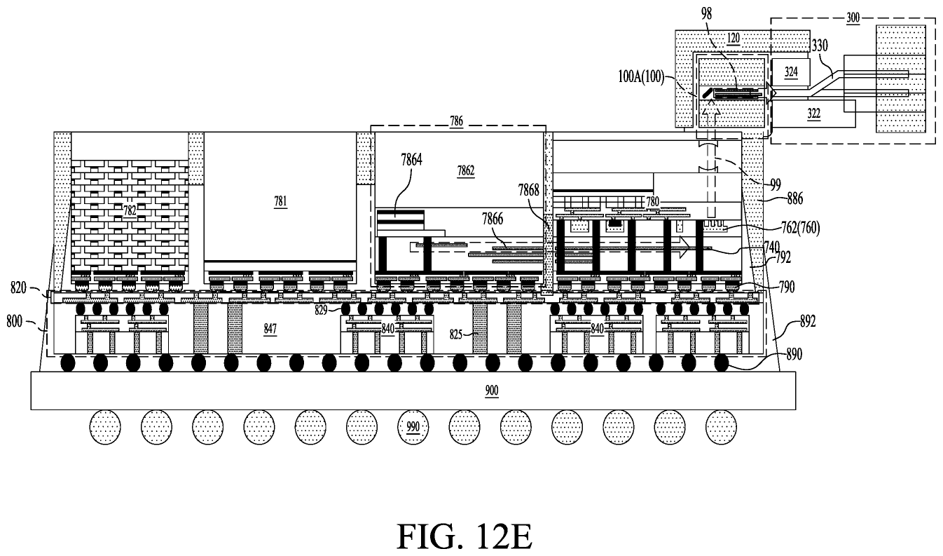

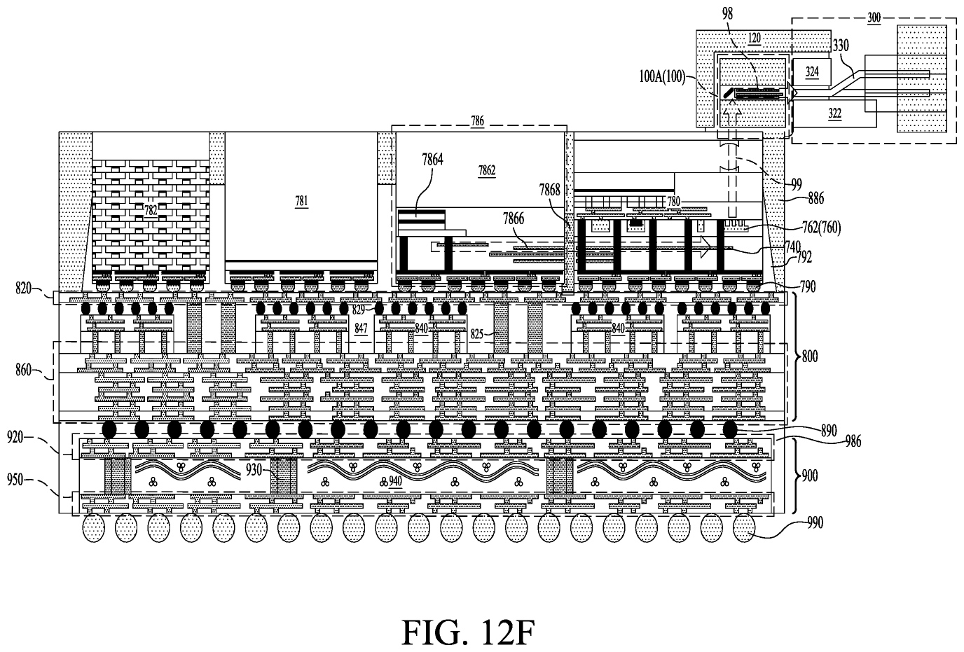

FIGS. 12A-12F are vertical cross-sectional views of various configurations of an eighth embodiment structure according to an aspect of the present disclosure.

Referring to FIG. 12A, a first configuration of the eighth embodiment structure may be derived from the first configuration of the eighth embodiment structure illustrated in FIG. 11A by attaching a light-emitting die 786 to the interposer 800 through an array of first solder material portions 790. The light-emitting die 786 comprises a substrate 7862, at least one light emitting element 7864 (such as a laser element), and waveguides 7866 that are optically coupled to the at least one light emitting element 7864. The light-emitting die 786 may be placed adjacent to the composite die 780 such that the waveguides 7866 within the light-emitting die 786 are aligned to waveguides 740 within the PIC die 700. The optical coupling between the waveguides 7866 within the light-emitting die 786 and the waveguides 740 within the PIC die 700 may be provided through an additional optical glue portion 7868 that is provided between the composite die 780 and the light-emitting die 786. In one embodiment, the additional optical glue portion 7868 may contact a sidewall of the light-emitting die 786 and a sidewall of the composite die 780, which comprises a sidewall of the PIC die 700. In this embodiment, the vertically-extending beam path 99 may be a bidirectional beam path, and the horizontally-extending beam path 98 may be a bidirectional beam path.

Referring to FIG. 12B, a second configuration of the eighth embodiment structure may be derived from the second configuration of the eighth embodiment structure illustrated in FIG. 11B by attaching a light-emitting die 786 to the interposer 800 through an array of first solder material portions 790.

Referring to FIG. 12C, a third configuration of the eighth embodiment structure may be derived from the third configuration of the eighth embodiment structure illustrated in FIG. 11C by attaching a light-emitting die 786 to the interposer 800 through an array of first solder material portions 790.

Referring to FIG. 12D, a fourth configuration of the eighth embodiment structure may be derived from the fourth configuration of the eighth embodiment structure illustrated in FIG. 11D by attaching a light-emitting die 786 to the interposer 800 through an array of first solder material portions 790.

Referring to FIG. 12E, a fifth configuration of the eighth embodiment structure may be derived from the fifth configuration of the eighth embodiment structure illustrated in FIG. 11E by attaching a light-emitting die 786 to the interposer 800 through an array of first solder material portions 790.

Referring to FIG. 12F, a sixth configuration of the eighth embodiment structure may be derived from the sixth configuration of the eighth embodiment structure illustrated in FIG. 11F by attaching a light-emitting die 786 to the interposer 800 through an array of first solder material portions 790.

Additional configurations of the eighth embodiment structure may be derived from any other configuration of the eighth embodiment structure or from any other embodiment structures described above by optically connecting a light-emitting die 786 to the interposer 800 through an array of first solder material portions 790, and by optically connecting the waveguides 7866 within the light-emitting die 786 with the waveguides in the PIC die 700.

While the various configurations described with reference to FIGS. 12A-12F provide examples in which the vertically-extending beam path 99 may be used as a bidirectional beam path, and the horizontally-extending beam path 98 may be a bidirectional beam path, it is understood that photonic devices 750 provided within the PIC die 700 in any configuration of the embodiment structures of the present disclosure may comprise at least one light-emitting element such as at least one laser element. Thus, the vertically-extending beam path 99 is inherently capable of being used as a bidirectional vertical beam path, and the horizontally-extending beam path 98 is inherently capable of being used as a bidirectional horizontal beam path.

Referring collectively to all embodiments in which fiber array units assembly 300 is attached to an optical connector unit 100 and according to an aspect of the present disclosure, a photonic assembly is provided, which comprises: a composite die 780 including a photonic integrated circuits (PIC) die 700 and an electronic integrated circuits (EIC) die 600, the PIC die 700 comprising waveguides 740 and photonic devices 750 therein, and the EIC die 600 comprising semiconductor devices 620 therein; an optical connector unit 100 comprising a first connector-side mirror reflector 160 and a first transition edge coupler 140 and proximal to or on a top surface of the composite die 780, wherein the first connector-side mirror reflector 160 is configured to change a beam direction between a vertically-extending beam path 99 through the composite die 780 and a horizontally-extending beam path 98 through the first transition edge coupler 140; and a fiber array units assembly 300 attached to a sidewall of the optical connector unit 100.

In one embodiment, the photonic assembly comprises an encapsulation cover 120 having a horizontally-extending portion overlying the optical connector unit 100 (which may comprise an optical connector die (100A, 100B, 100C)) and a portion of the fiber array units assembly 300, and a vertically-extending portion that is attached to a sidewall of the optical connector unit 100 through the optical glue portion 130. In one embodiment, the composite die 780 comprises a support semiconductor substrate 510 interposed between the PIC die 700 and the optical connector unit 100; and the vertically-extending beam path 99 vertically extends through the support semiconductor substrate 510. In one embodiment, the optical connector unit 100 may comprise an optical connector die (100A, 100B, 100C) which comprises: a dielectric matrix layer 150 embedding the first connector-side mirror reflector 160 and the first transition edge coupler 140; a first spacer plate (111, 111′) located over the first connector-side mirror reflector 160 and more distal from the composite die 780 than the first connector-side mirror reflector 160; and a second spacer plate (112, 112′) interposed between the composite die 780 and the dielectric matrix layer 150.

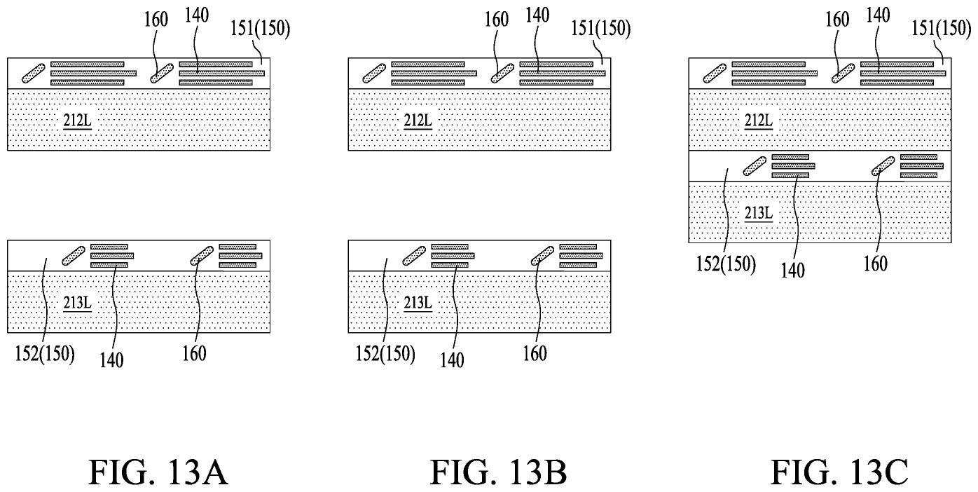

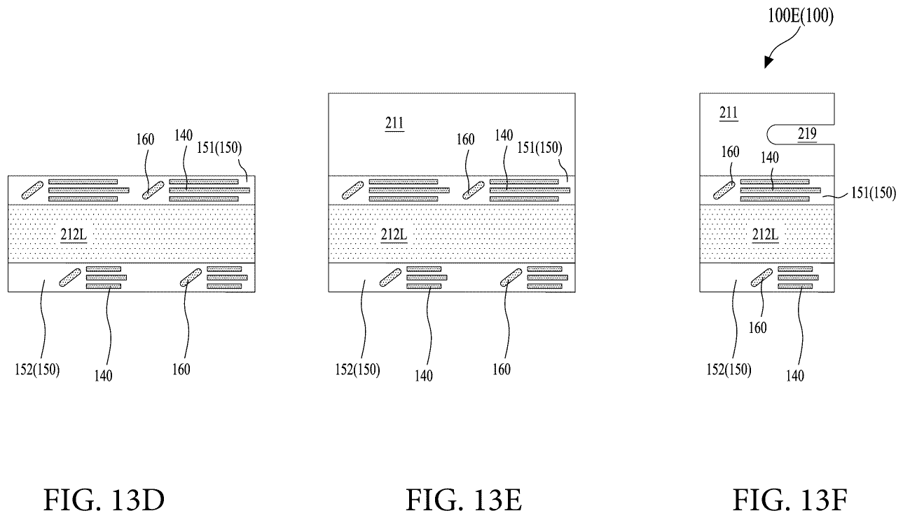

FIGS. 13A-13F are sequential vertical cross-sectional views of an exemplary structure during formation of an optical connector die 100E.

Referring to FIG. 13A, a first dielectric matrix layer 151 embedding an array of combinations of a first connector-side mirror reflector 160 and a first transition edge coupler 140 may be formed over a spacer plate layer 212L. The spacer plate layer 212L comprises a solid material having an optical extinction coefficient smaller than 0.01 within a wavelength range from 1 micron to 2 microns. For example, the spacer plate layer 212L comprises silicon. A second dielectric matrix layer 151 embedding an array of combinations of a second connector-side mirror reflector 160 and a second transition edge coupler 140 may be formed over a carrier substrate 213L. Each of the first dielectric matrix layer 151 and the second dielectric matrix layer 152 may be a dielectric matrix layer 150, and may have the same material composition and the same thickness range as the dielectric matrix layer 150 described above.

Referring to FIG. 13B, the spacer plate layer 212L may be thinned to a thickness in a range from 10 microns to 300 microns, such as from 20 microns to 150 microns. A backside polishing process may be used to thin the spacer plate layer 212L.

Referring to FIG. 13C, a top surface of the second dielectric matrix layer 152 may be bonded to the bottom surface of the spacer plate layer 212L by inducing a semiconductor-to-insulator bonding such as a silicon-to-silicon oxide bonding. Alternatively, a bottom surface portion of the spacer plate layer 212L may be oxidized into a semiconductor oxide layer such as a silicon oxide layer, and an insulator-to-insulator bonding such as silicon oxide-to-silicon oxide bonding may be induced to bond the second dielectric matrix layer 152 to the spacer plate layer 212L.

Referring to FIG. 13D, the carrier substrate 213L may be detached from an assembly of the second dielectric matrix layer 152, the spacer plate layer 212L, and the first dielectric matrix layer 151. For example, a polishing process, a grinding process, a selective isotropic etch process, and/or a selective anisotropic etch process may be used to remove the carrier substrate 213L. Alternatively or additionally, a cleaving process may be used to remove a predominant portion of the carrier substrate 213L.

Referring to FIG. 13E, a support matrix 211 may be attached to the top surface of the first dielectric matrix layer 151. In one embodiment, the support matrix 211 comprises an insulating material such as silicon oxide, and may have a thickness in a range from 100 microns to 600 microns, such as from 200 microns to 400 microns, although lesser and greater thicknesses may also be used. Generally, an assembly is provided, which comprises at least one first connector-side mirror reflector 160 and at least one first transition edge coupler 140 embedded in a first dielectric matrix layer 151, and at least one second connector-side mirror reflector 160 and at least one second transition edge coupler 140 embedded in a second dielectric matrix layer 151, and a spacer plate layer 212L. The assembly is attached to a support matrix 211.

Referring to FIG. 13F, the assembly of the support matrix 211, the first dielectric matrix layer 151, the spacer plate layer 212L, and the second dielectric matrix layer 152 may be diced along dicing channels to form a plurality of optical connector dies 110E, which are optical connector units 100. Each optical connector die comprises a spacer plate 212, a first dielectric matrix layer 151 embedding a first connector-side mirror reflector 160 and a first transition edge coupler 140 and located on one side of the spacer plate 212, a second dielectric matrix layer 152 embedding a second connector-side mirror reflector 160 and a second transition edge coupler 140 and located on another side of the spacer plate 212, and a support matrix 211. In one embodiment, sidewalls of the spacer plate 212, the first dielectric matrix layer 151, the second dielectric matrix layer 152, and the support matrix 211 may be vertically coincident with one another within each optical connector die 100E.

According to an aspect of the present disclosure, a plurality of receptacle cavities 219 may be formed from a sidewall of the support matrix 211. As used herein, a receptacle cavity 219 refers to a cavity that is configured to receive a structural element that is inserted into the cavity. In one embodiment, the plurality of receptacle cavities 219 comprises a row of receptacle cavities 219 that are arranged along a horizontal direction. Each of the receptacle cavities 219 may comprise a respective cylindrical cavity portion having a uniform vertical cross-sectional shape that is invariant along a depth direction of the receptacle cavity 219. The uniform vertical cross-sectional shape may comprise a circular shape or an elliptical shape. The lateral dimension (such as width or a diameter) of each receptacle cavity 219 may be in a range from 50 microns to 400 microns, such as from 100 microns to 200 microns, although lesser and greater dimensions may also be used. The depth of each receptacle cavity 219 may be in a range from 100 microns to 1,000 microns, such as from 200 microns to 600 microns, although lesser and greater depths may also be used.

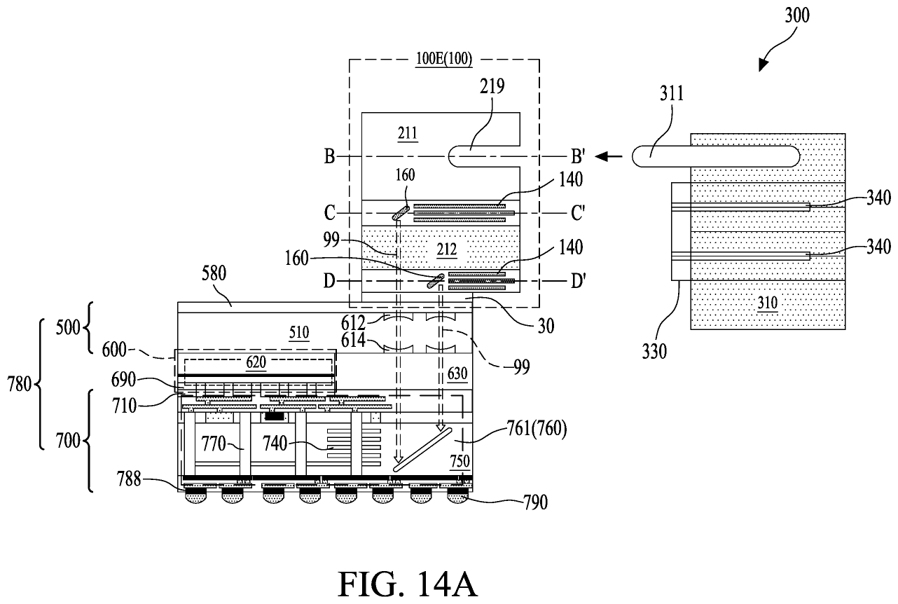

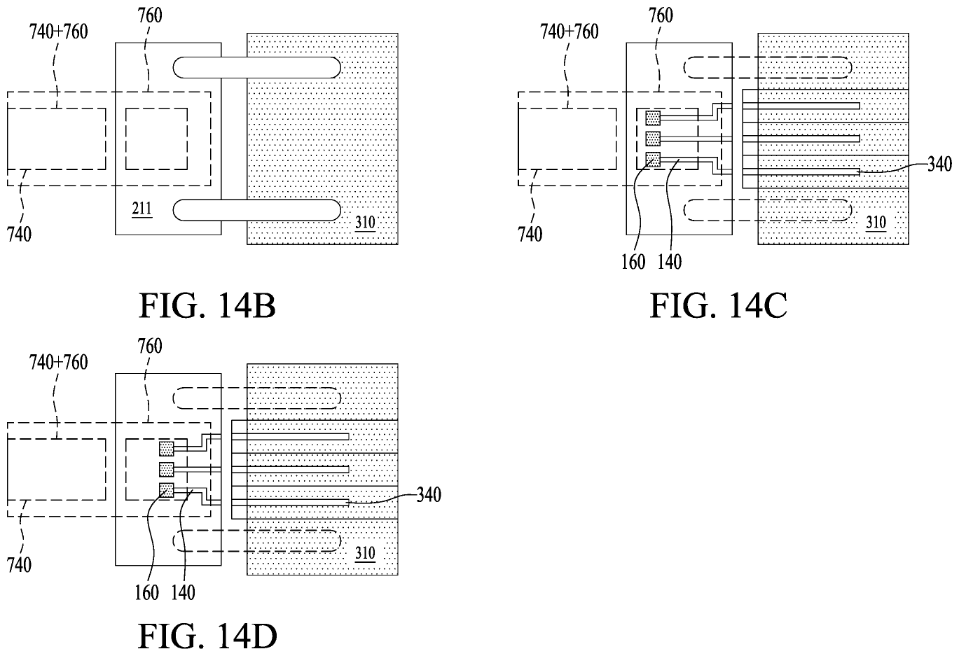

FIG. 14A is a vertical cross-sectional view of a ninth embodiment structure of the present disclosure. FIG. 14B is a horizontal cross-sectional view along the horizontal plane B-B′ of the ninth embodiment structure of FIG. 14A. FIG. 14C is a horizontal cross-sectional view of the ninth embodiment structure of FIG. 14A. FIG. 14D is a horizontal cross-sectional view of the ninth embodiment structure of FIG. 14A. FIG. 14A is illustrated prior to inserting dowels 311 in a fiber array units assembly 300 into receptacle cavities 219 in an optical connector die 100E. FIGS. 14B, 14C, and 14D are illustrated after insertion of the dowels 311 in the fiber array units assembly 300 into the receptacle cavities 219 in the optical connector die 100E. The locations of an optical deflector 760 and waveguides 740 that are coupled to the optical deflector 760 in a plan view are represented in dotted rectangles in FIGS. 14B, 14C, and 14D. Locations of the dowels 311 in a plan view are represented in dotted lines in FIGS. 14C and 14D.

Referring to FIGS. 14A-14D, the ninth embodiment structure of the present disclosure may be derived from any of the previously described embodiment structures that uses an in-die mirror 761 as an optical deflector 760 by using an optical connector die 100E provided at the processing steps of FIG. 13F as an optical connector unit 100. The optical connector die 100E comprises a support matrix 211 that is attached to the first connector-side mirror reflector 160 and a first transition edge coupler 140. The optical connector die 100E may comprise a spacer plate 212 that is interposed between a combination of the first connector-side mirror reflector 160 and a first transition edge coupler 140 and a combination of a second connector-side mirror reflector 160 and a second transition edge coupler 140. In this embodiment, the optical connector die 100E may be attached to the top surface of the composite die 780 such that each of the connector-side mirror reflectors 160 intersects a respective one of the vertically-extending beam paths 99. The support matrix 211 comprises a plurality of receptacle cavities 219 therein. The plurality of receptacle cavities 219 laterally extend along a horizontal direction, which is parallel to the direction of a horizontally propagating optical beam through the transition edge couplers 140.

A fiber array units assembly 300 configured to mate with the optical connector die 100E is provided. The fiber array units assembly 300 illustrated in FIGS. 14A-14D comprises a fiber array matrix 310, an array of optical fibers 340 embedded within the fiber array matrix 310, and a plurality of dowels 311 attached to, and protruding outward from, the fiber array matrix 310. The plurality of dowels 311 is configured to be fitted into a respective one of the plurality of receptacle cavities 219 in an optical connector die 100E prepared through the processing steps of FIGS. 13A-13F. A fiber cladding 330 may surround the optical fibers 340. The fiber array units assembly 300 comprises a plurality of rows of optical fibers 340. Each row of the optical fibers 340 may be aligned to a respective transition edge coupler 140. For example, a first row of optical fibers 340 may be aligned to a first transition edge coupler 140, and a second row of optical fibers 340 may be aligned to a second transition edge coupler 140.

The fiber array units assembly 300 may be reversibly mounted onto the optical connector die 100E by inserting the dowels 311 into the receptacle cavities 219. As used herein, a first element is reversibly mounted onto a second element in instances in which the first element is mounted onto the second element in a manner that provides dismounting of the first element without structural damage to the first element or to the second element. In one embodiment, the fiber array units assembly 300 may be reversibly mounted onto the optical connector die 100E by sliding the dowels 311 into the receptacle cavities 219. Upon mounting of the fiber array units assembly 300 onto the optical connector die 100E, each row of optical fibers 340 may be mounted to a respective transition edge coupler 140 that is located within the optical connector die 100E.

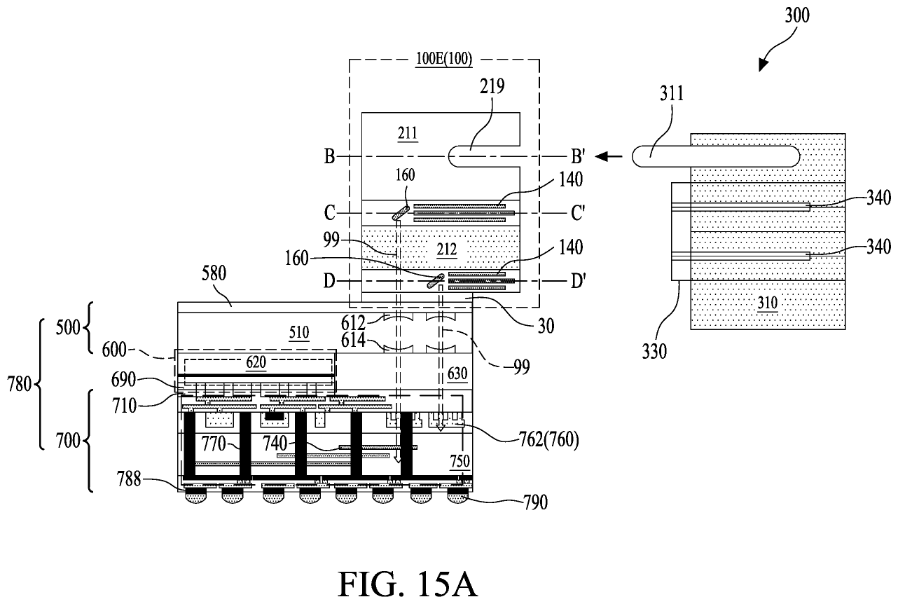

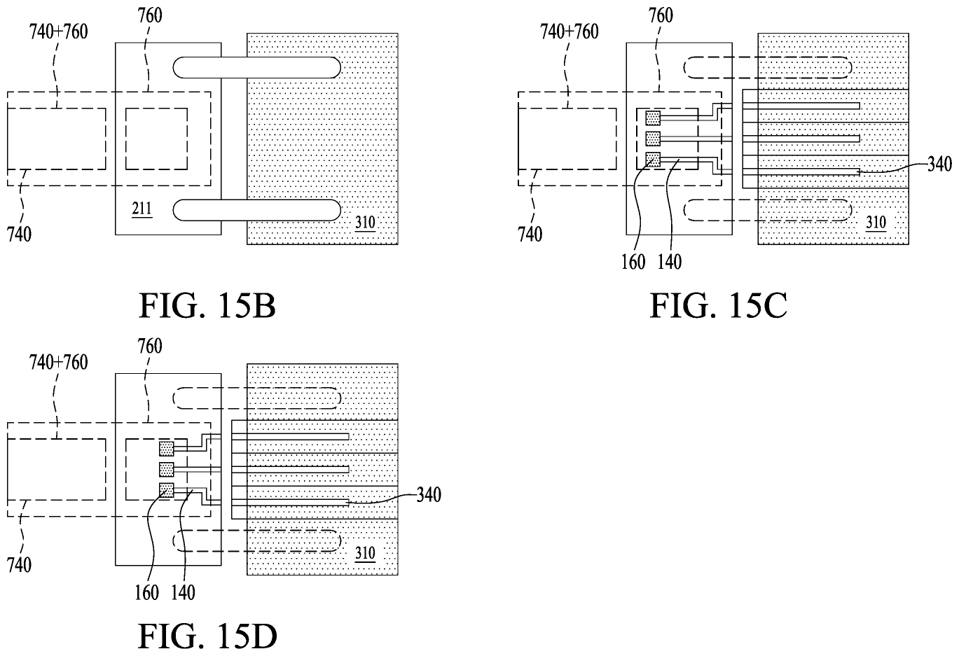

FIG. 15A is a vertical cross-sectional view of a tenth embodiment structure of the present disclosure. FIG. 15B is a horizontal cross-sectional view along the horizontal plane B-B′ of the tenth embodiment structure of FIG. 15A. FIG. 15C is a horizontal cross-sectional view of the tenth embodiment structure of FIG. 15A. FIG. 15D is a horizontal cross-sectional view of the tenth embodiment structure of FIG. 15A. FIG. 15A is illustrated prior to inserting dowels 311 in a fiber array units assembly 300 into receptacle cavities 219 in an optical connector die 100E. FIGS. 15B, 15C, and 15D are illustrated after insertion of the dowels 311 in the fiber array units assembly 300 into the receptacle cavities 219 in the optical connector die 100E. The locations of an optical deflector 760 and waveguides 740 that are coupled to the optical deflector 760 in a plan view are represented in dotted rectangles in FIGS. 15B, 15C, and 15D. Locations of the dowels 311 in a plan view are represented in dotted lines in FIGS. 15C and 15D.

Referring to FIGS. 15A-15D, the tenth embodiment structure of the present disclosure may be derived from any of the previously described embodiment structures that uses a grating coupler 762 as an optical deflector 760 by using an optical connector die 100E provided at the processing steps of FIG. 13F as an optical connector unit 100. The fiber array units assembly 300 used in the tenth embodiment structure may be the same as the fiber array units assembly 300 used in the ninth embodiment structure.

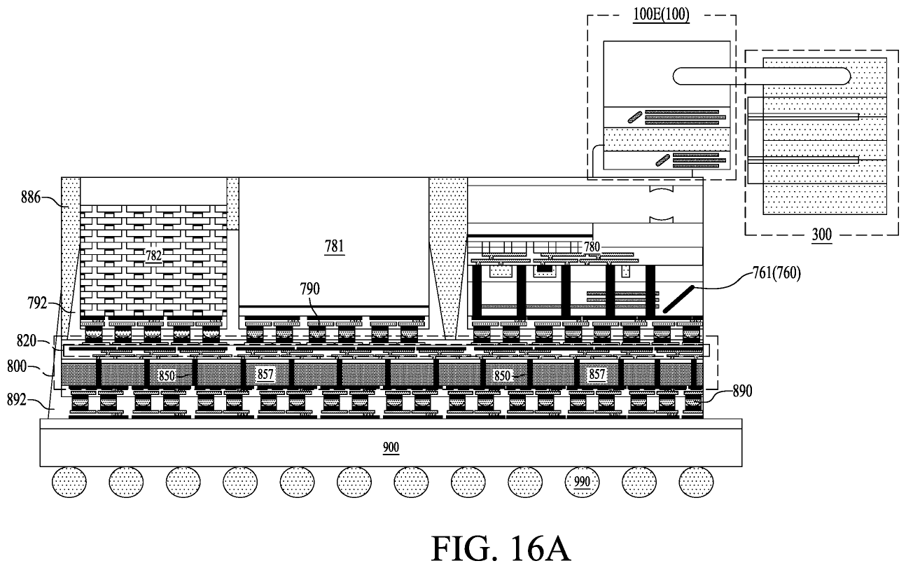

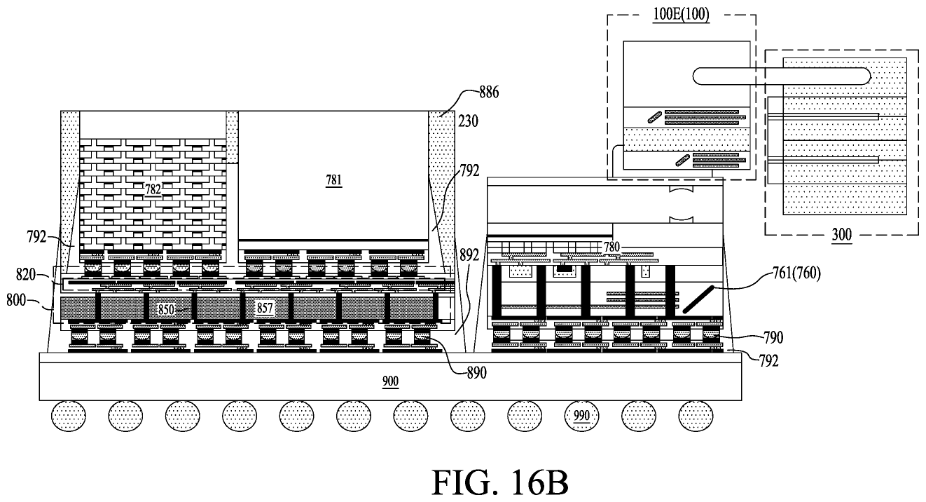

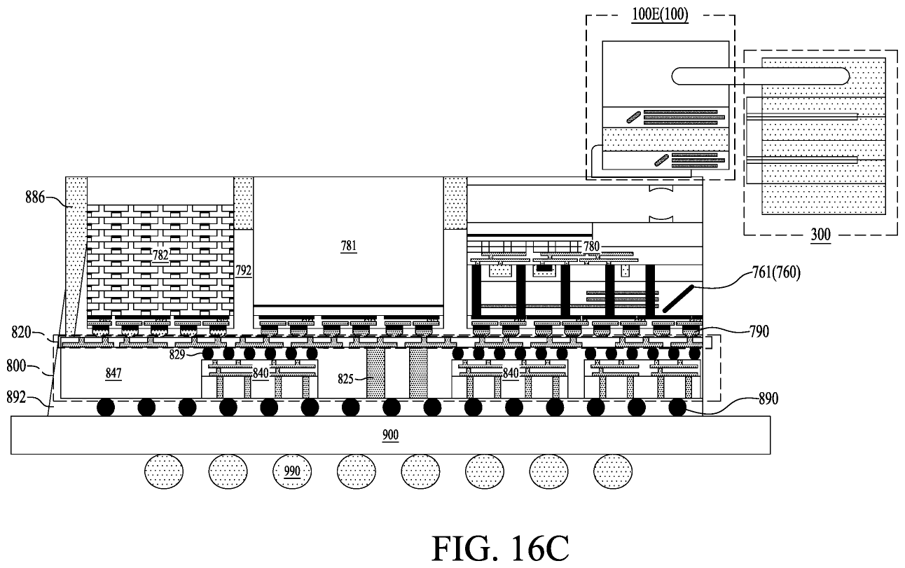

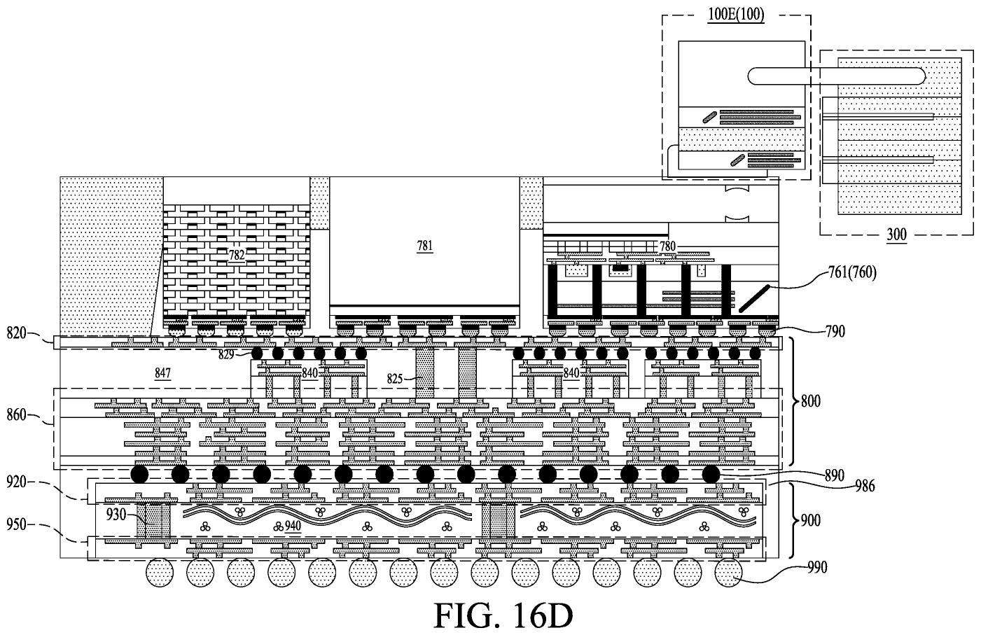

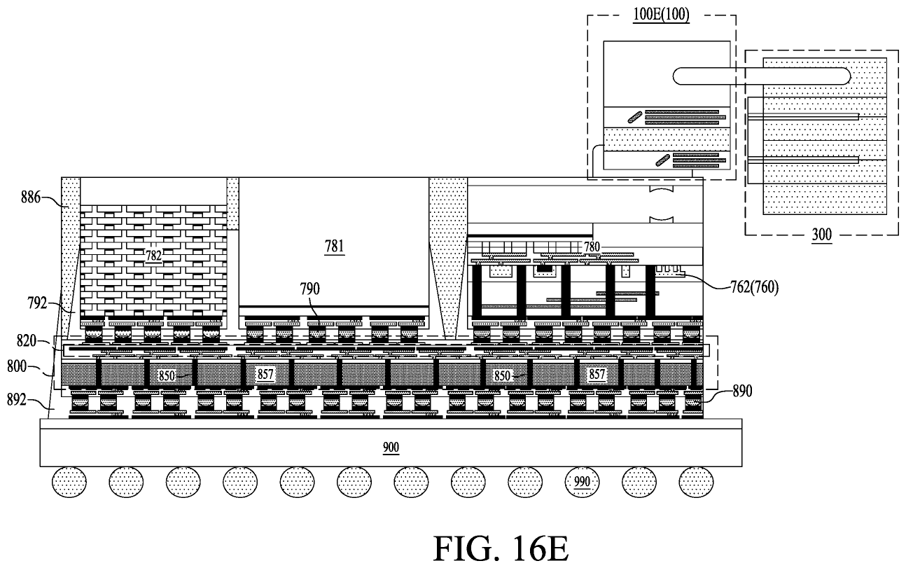

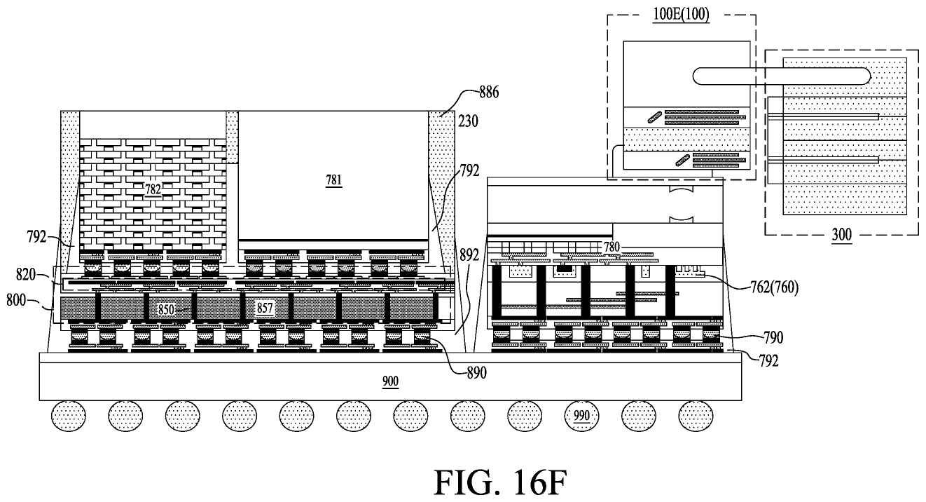

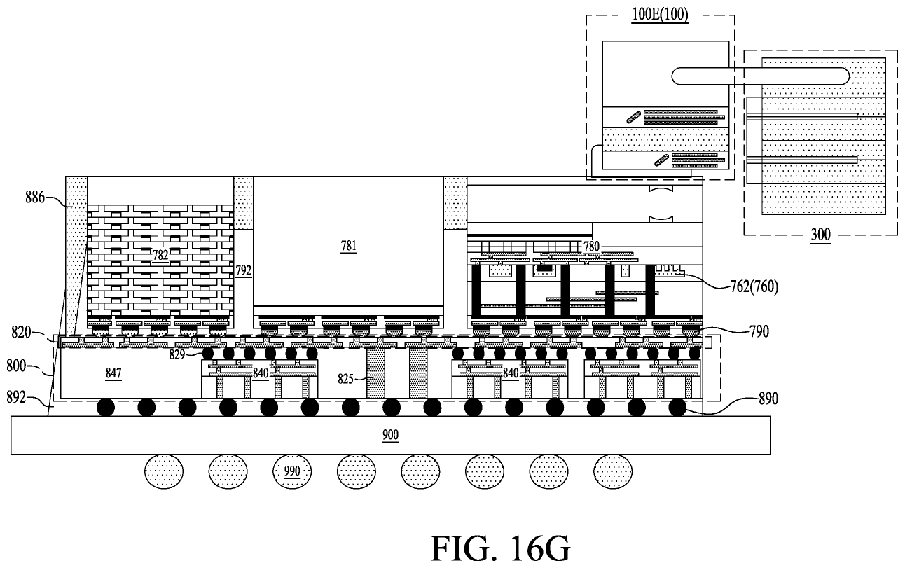

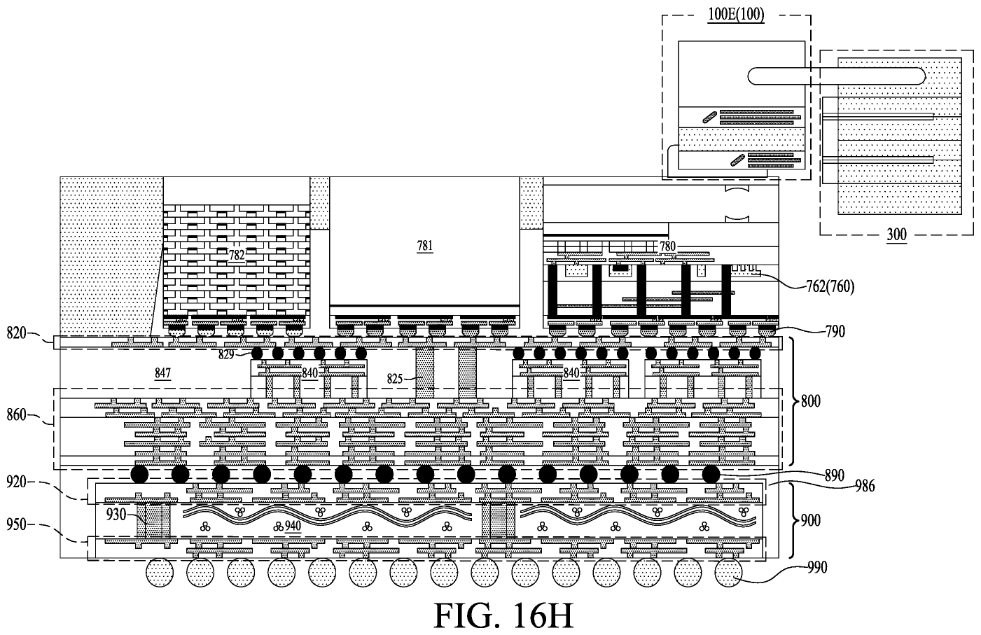

FIGS. 16A-16H are vertical cross-sectional views of various configurations of an eleventh embodiment structure according to an aspect of the present disclosure.

Referring to FIG. 16A, a first configuration of the eleventh exemplary structure may be derived from the first configuration of the sixth exemplary structure illustrated in FIG. 9A by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

Referring to FIG. 16B, a second configuration of the eleventh exemplary structure may be derived from the second configuration of the sixth exemplary structure illustrated in FIG. 9B by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

Referring to FIG. 16C, a third configuration of the eleventh exemplary structure may be derived from the third configuration of the sixth exemplary structure illustrated in FIG. 9C by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

Referring to FIG. 16D, a fourth configuration of the eleventh exemplary structure may be derived from the fourth configuration of the sixth exemplary structure illustrated in FIG. 9D by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

Referring to FIG. 16E, a fifth configuration of the eleventh exemplary structure may be derived from the fifth configuration of the sixth exemplary structure illustrated in FIG. 9E by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

Referring to FIG. 16F, a sixth configuration of the eleventh exemplary structure may be derived from the sixth configuration of the sixth exemplary structure illustrated in FIG. 9F by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

Referring to FIG. 16G, a seventh configuration of the eleventh exemplary structure may be derived from the seventh configuration of the sixth exemplary structure illustrated in FIG. 9G by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

Referring to FIG. 16H, an eighth configuration of the eleventh exemplary structure may be derived from the eighth configuration of the sixth exemplary structure illustrated in FIG. 9H by using the optical connector die 100E illustrated in FIGS. 13F, 14A-14D, and 15A-15D are an optical connector unit 100, and by using the fiber array units assembly 300 illustrated in FIGS. 14A-14D and 15A-15D to provide optical coupling to the optical connector die 100E.

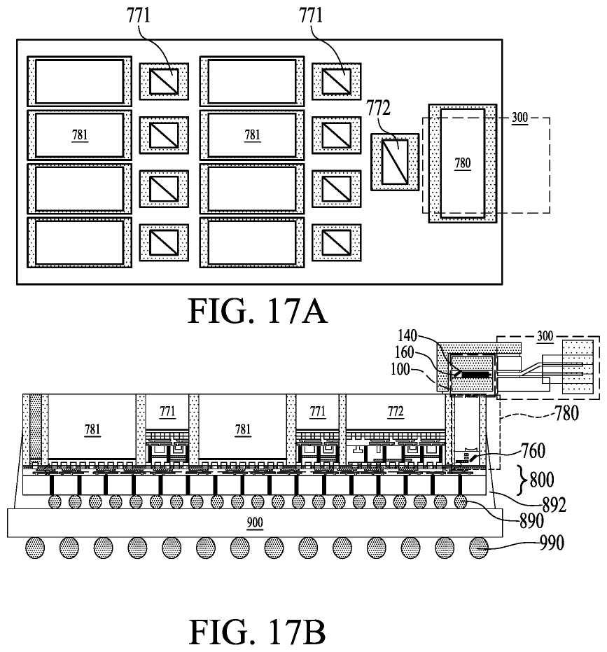

FIG. 17A is a vertical cross-sectional view of a twelfth embodiment structure according to an aspect of the present disclosure. FIG. 17B is a top-down view of the twelfth embodiment structure of FIG. 17A.

Referring to FIGS. 17A and 17B, the twelfth embodiment structure comprises a photonic assembly based on at least one application-specific integrated circuit (ASIC) die 781. The twelfth embodiment structure comprises at least one ASIC die 781, a composite die 780, at least one first-level memory die 771, and at least one second-level memory die 772. The composite die 780 may be any of the composite dies 780 described above. Each first-level memory die 771 may provide fast memory access with a lesser total memory capacity, and each second-level memory die 772 may provide slow memory access with a greater total memory capacity. An optical connector unit 100 may be provided within, or on, the composite die 780. A fiber array units assembly 300 may be attached to the optical connector unit 100. The optical connector unit 100 may be any of the previously described optical connector units 100, and the fiber array units assembly 300 may be selected to be compatible with the optical connector unit 100.

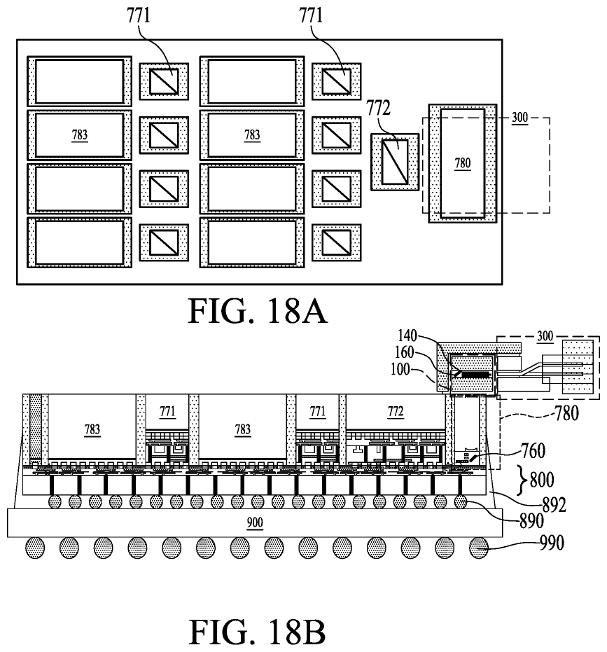

FIG. 18A is a vertical cross-sectional view of a twelfth embodiment structure according to an aspect of the present disclosure. FIG. 18B is a top-down view of the twelfth embodiment structure of FIG. 18A.

Referring to FIGS. 18A and 18B, the thirteenth embodiment structure comprises a photonic assembly based on at least one memory die 783. The twelfth embodiment structure comprises at least one memory die 783, a composite die 780, at least one first-level memory die 771 that is in communication with a respective memory die 783, and at least one second-level memory die 772 that is in communication with a respective memory die 783. Each first-level memory die 771 may provide fast memory access with a lesser total memory capacity, and each second-level memory die 772 may provide slow memory access with a greater total memory capacity. An optical connector unit 100 may be provided within, or on, the composite die 780. A fiber array units assembly 300 may be attached to the optical connector unit 100. The optical connector unit 100 may be any of the previously described optical connector units 100, and the fiber array units assembly 300 may be selected to be compatible with the optical connector unit 100.

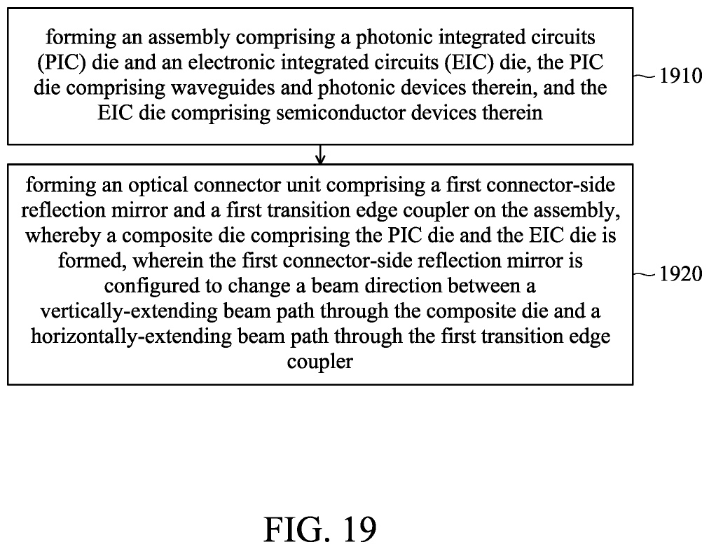

FIG. 19 is a flowchart illustrating general processing steps for forming a photonic assembly of the present disclosure.

Referring to step 1910, an assembly including a photonic integrated circuits (PIC) die 700 and an electronic integrated circuits (EIC) die 600 is formed. The PIC die 700 comprises waveguides 740 and photonic devices 750 therein. The EIC die 600 comprises semiconductor devices 620 therein.

Referring to step 1920, an optical connector unit 100 is formed on the assembly, whereby a composite die comprising the PIC die 700 and the EIC die 600 is formed. The optical connector unit 100 comprises a first connector-side mirror reflector 160 and a first transition edge coupler 140. The optical connector unit 100 is formed within, or on, the composite die 780. The first connector-side mirror reflector 160 is configured to change a beam direction between a vertically-extending beam path 99 through the composite die 780 and a horizontally-extending beam path 98 through the first transition edge coupler 140.

Referring to all drawings and according to various embodiments of the present disclosure, a photonic assembly is provided, which comprises: a composite die 780 including a photonic integrated circuits (PIC) die 700 and an electronic integrated circuits (EIC) die 600, the PIC die 700 comprising waveguides 740 and photonic devices 750 therein, and the EIC die 600 comprising semiconductor devices 620 therein; and an optical connector unit 100 located proximal to a top surface of the composite die and comprising a first connector-side mirror reflector 160 and a first transition edge coupler 140, wherein the first connector-side mirror reflector 160 is configured to change a beam direction between a vertically-extending beam path 99 through the composite die 780 and a horizontally-extending beam path 98 through the first transition edge coupler 140.

In one embodiment, the optical connector unit 100 comprises an optical connector die (100A, 100B, 100C, 100E) that is attached to a top surface of the composite die 780. In one embodiment, the photonic assembly comprises an optical glue portion 130 bonding a bottom surface of the optical connector die (100A, 100B, 100C, 100E) to the top surface of the composite die 780. In one embodiment, the photonic assembly comprises an encapsulation cover 120 having a horizontally-extending portion overlying the optical connector die (100A, 100B, 100C, 100E) and a vertically-extending portion that is attached to a sidewall of the optical connector die (100A, 100B, 100C, 100E) through the optical glue portion 130.

In one embodiment, the composite die 780 comprises a support semiconductor substrate 510 interposed between the PIC die 700 and the optical connector unit 100; and the vertically-extending beam path 99 vertically extends through the support semiconductor substrate 510. In one embodiment, the photonic assembly comprises an optically transparent dielectric layer 580 overlying a top surface of the support semiconductor substrate 510, wherein the optical connector unit 100 is located over the optically transparent dielectric layer 580. In one embodiment, the optical connector unit 100 is embedded within the optically transparent dielectric layer 580.

In one embodiment, the optical connector unit 100 comprises a support matrix 211 that is attached to the first connector-side mirror reflector 160 and a first transition edge coupler 140; and the support matrix 211 comprises a plurality of receptacle cavities 219 therein. In one embodiment, the photonic assembly comprises a fiber array units assembly 300 comprising a fiber array matrix 310, an array of optical fibers 340 embedded within the fiber array matrix 310, and a plurality of dowels 311 attached to, and protruding outward from, the fiber array matrix 310 and fitted into a respective one of the plurality of receptacle cavities 219.

In one embodiment, the optical connector unit 100 comprises: a dielectric matrix layer 150 embedding the first connector-side mirror reflector 160 and the first transition edge coupler 140; a first spacer plate 111 located over the first connector-side mirror reflector 160 and more distal from the composite die 780 than the first connector-side mirror reflector 160; and a second spacer plate 112 interposed between the composite die 780 and the dielectric matrix layer 150.

According to another aspect of the present disclosure, a photonic assembly is provided, which comprises: a composite die 780 including a photonic integrated circuits (PIC) die 700, an electronic integrated circuits (EIC) die 600, and a support semiconductor substrate 510 overlying the PIC die 700 and the EIC die 600, the PIC die 700 comprising an optical deflector 760; and an optical connector unit 100 proximal to a top surface of the composite die and comprising a first connector-side mirror reflector 160 and a first transition edge coupler 140, wherein the first connector-side mirror reflector 160 is configured to change a beam direction between a vertically-extending beam path 99 extending between the optical deflector 760 and the first connector-side mirror reflector 160 and through the support semiconductor substrate 510 and a first horizontally-extending beam path 98 through the first transition edge coupler 140.

In one embodiment, the PIC die 700 comprises waveguides 740 that laterally extend along a horizontal direction; and the optical deflector 760 comprises an in-die mirror 761 configured to change the beam direction between a second horizontally-extending beam path 98 through a subset of the waveguides 740 and the vertically-extending beam path 99. In one embodiment, the optical deflector 760 comprises a grating coupler 762 comprising an optical grating having a periodicity along a horizontal direction.

In one embodiment, the optical connector unit 100 comprises a second connector-side mirror reflector 160 and a second transition edge coupler 140 that are located at a different vertical distance from the composite die 780 than the first connector-side mirror reflector 160 and the first transition edge coupler 140 are from the composite die 780. In one embodiment, the first connector-side mirror reflector 160 and a first transition edge coupler 140 are located in an optical connector die (100A, 100B, 100C, 100E); and the optical connector die (100A, 100B, 100C, 100E) comprises a support matrix 211 comprising a plurality of receptacle cavities 219 that laterally extend along a horizontal direction.

The various embodiments of the present disclosure may be used to provide optical coupling between a composite die 780 including a PIC die 700 and an EIC die 600 and optical fibers 340 that laterally extend along a horizontal direction. An optical connector unit 100 that deflects light along a horizontal direction may be provided on, or within, the composite die 780, and may be advantageously used to provide optical coupling with the optical fibers 340 that laterally extend along the horizontal direction. By aligning the optical fibers 340 along the horizontal direction, the total dimension of the photonic assembly along the vertical direction may be reduced, and the photonic assembly may be fitted into a volume having a reduced height.

The foregoing outlines features of several embodiments so that those skilled in the art may better understand the aspects of the present disclosure. Each embodiment described using the term “comprises” also inherently discloses additional embodiments in which the term “comprises” is replaced with “consists essentially of” or with the term “consists of,” unless expressly disclosed otherwise herein. Whenever two or more elements are listed as alternatives in a same paragraph of in different paragraphs, a Markush group including a listing of the two or more elements is also impliedly disclosed. Whenever the auxiliary verb “may” is used in this disclosure to describe formation of an element or performance of a processing step, an embodiment in which such an element or such a processing step is not performed is also expressly contemplated, provided that the resulting apparatus or device may provide an equivalent result. As such, the auxiliary verb “may” as applied to formation of an element or performance of a processing step should also be interpreted as “may” or as “may, or may not” whenever omission of formation of such an element or such a processing step is capable of providing the same result or equivalent results, the equivalent results including somewhat superior results and somewhat inferior results. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic assembly comprising:
a composite die including a photonic integrated circuits (PIC) die and an electronic integrated circuits (EIC) die, the PIC die comprising waveguides and photonic devices therein, and the EIC die comprising semiconductor devices therein; and
an optical connector unit proximal to a top surface of the composite die and comprising a first connector-side mirror reflector and a first transition edge coupler, wherein the first connector-side mirror reflector is configured to change a beam direction between a vertically-extending beam path through the composite die and a horizontally-extending beam path through the first transition edge coupler.

2. The photonic assembly of claim 1, wherein the optical connector unit comprises an optical connector die that is attached to a top surface of the composite die.

3. The photonic assembly of claim 2, wherein further comprising an optical glue portion bonding a bottom surface of the optical connector die to the top surface of the composite die.

4. The photonic assembly of claim 3, further comprising an encapsulation cover having a horizontally-extending portion overlying the optical connector die and a vertically-extending portion that is attached to a sidewall of the optical connector die through the optical glue portion.

5. The photonic assembly of claim 1, wherein:
the composite die comprises a support semiconductor substrate interposed between the PIC die and the optical connector unit; and
the vertically-extending beam path vertically extends through the support semiconductor substrate.

6. The photonic assembly of claim 5, further comprising an optically transparent dielectric layer overlying a top surface of the support semiconductor substrate, wherein the optical connector unit is located over the optically transparent dielectric layer.

7. The photonic assembly of claim 6, wherein the optical connector unit is embedded within the optically transparent dielectric layer.

8. The photonic assembly of claim 1, wherein:
the optical connector unit comprises a support matrix that is attached to the first connector-side mirror reflector and a first transition edge coupler; and
the support matrix comprises a plurality of receptacle cavities therein.

9. The photonic assembly of claim 8, further comprising a fiber array units assembly comprising a fiber array matrix, an array of optical fibers embedded within the fiber array matrix, and a plurality of dowels attached to, and protruding outward from, the fiber array matrix and fitted into a respective one of the plurality of receptacle cavities.

10. The photonic assembly of claim 1, wherein the optical connector unit comprises:
a dielectric matrix layer embedding the first connector-side mirror reflector and the first transition edge coupler;
a first spacer plate located over the first connector-side mirror reflector and more distal from the composite die than the first connector-side mirror reflector; and
a second spacer plate interposed between the composite die and the dielectric matrix layer.

11. A photonic assembly comprising:
a composite die including a photonic integrated circuits (PIC) die, an electronic integrated circuits (EIC) die, and a support semiconductor substrate overlying the PIC die and the EIC die, the PIC die comprising an optical deflector; and
an optical connector unit proximal to a top surface of the composite die and comprising a first connector-side mirror reflector and a first transition edge coupler, wherein the first connector-side mirror reflector is configured to change a beam direction between a vertically-extending beam path extending between the optical deflector and the first connector-side mirror reflector and through the support semiconductor substrate and a first horizontally-extending beam path through the first transition edge coupler.

12. The photonic assembly of claim 11, wherein:
the PIC die comprises waveguides that laterally extend along a horizontal direction; and
the optical deflector comprises an in-die mirror configured to change the beam direction between a second horizontally-extending beam path through a subset of the waveguides and the vertically-extending beam path.

13. The photonic assembly of claim 11, wherein the optical deflector comprises a grating coupler comprising an optical grating having a periodicity along a horizontal direction.

14. The photonic assembly of claim 11, wherein the optical connector unit comprises a second connector-side mirror reflector and a second transition edge coupler that are located at a different vertical distance from the composite die than the first connector-side mirror reflector and the first transition edge coupler are from the composite die.

15. The photonic assembly of claim 11, wherein:
the first connector-side mirror reflector and a first transition edge coupler are located in an optical connector die; and
the optical connector die comprises a support matrix comprising a plurality of receptacle cavities that laterally extend along a horizontal direction.

16. A method of forming a photonic assembly, the method comprising:
forming an assembly comprising a photonic integrated circuits (PIC) die and an electronic integrated circuits (EIC) die, the PIC die comprising waveguides and photonic devices therein, and the EIC die comprising semiconductor devices therein; and
forming an optical connector unit comprising a first connector-side mirror reflector and a first transition edge coupler on the assembly, whereby a composite die comprising the PIC die and the EIC die is formed, wherein the first connector-side mirror reflector is configured to change a beam direction between a vertically-extending beam path through the composite die and a horizontally-extending beam path through the first transition edge coupler.

17. The method of claim 16, wherein the optical connector unit comprises an optical connector die that is attached to a top surface of the composite die.

18. The method of claim 17, further comprising attaching an encapsulation cover to the optical connector die, wherein the encapsulation cover has a horizontally-extending portion overlying the optical connector die and a vertically-extending portion that is attached to a sidewall of the optical connector die through an optical glue portion.

19. The method of claim 16, wherein:
the composite die comprises an optically transparent dielectric layer overlying a top surface of a support semiconductor substrate; and
the optical connector unit is formed within the optically transparent dielectric layer.

20. The method of claim 16, wherein the optical connector unit is formed by:
attaching the first connector-side mirror reflector and a first transition edge coupler to a support matrix; and
forming a plurality of receptacle cavities from a sidewall of the support matrix.
